(19) United States
(12) Patent Application Publication
(10) Pub. No.: US 2026/0129463 A1
(43) Pub. Date: May 7, 2026

(54) ARTIFICIAL INTELLIGENCE RADIO ACCESS NETWORK SYSTEM AND METHODS FOR MODELING AND PREDICTING NON-TERRESTRIAL WIRELESS COVERAGE

(71) Applicants: AT&T Intellectual Property I, L.P., Atlanta, GA (US); AT&T Technical Services Company, Inc., Vienna, VA (US)

(72) Inventors: Daniel Vivanco, Ashburn, VA (US); David Ross Beppler, Duluth, GA (US)

(73) Assignees: AT&T Intellectual Property I, L.P., Atlanta, GA (US); AT&T Technical Services Company, Inc., Vienna, VA (US)

(21) Appl. No.: 18/937,162

(22) Filed: Nov. 5, 2024

(51) Int. Cl. H04W 16/14; H04B 7/185; H04W 84/06

(52) U.S. Cl. CPC H04W 16/14; H04B 7/18513; H04W 84/06

(57) ABSTRACT

Aspects of the subject disclosure may include, for example, receiving sensor information from a plurality of user equipment (UE) devices attached to a cellular network, the sensor information determined by a respective UE device based on a presence of satellite coverage of a non-terrestrial network detected by the respective UE device at a respective location of the respective UE device, predicting future coverage areas for the satellite coverage of the non-terrestrial network, wherein the predicting future coverage areas is based on the sensor information, and providing, to a remote UE in an area with no coverage from the cellular network, information about future coverage areas and future coverage times for the satellite coverage of the non-terrestrial network to enable the remote UE to schedule future network access with the non-terrestrial network. Other embodiments are disclosed.

### FIELD OF THE DISCLOSURE

The subject disclosure relates to a system and method for estimating and notifying satellite cell coverage to terrestrial user equipment (UEs) including Internet of Things (IoT) devices.

### BACKGROUND

User equipment including IoT devices may operate on both a terrestrial cellular communications network and a non-terrestrial satellite communications network. When no terrestrial network is available, such as in a remote location, the non-terrestrial network may be available as an alternative for communication using the cellular radio components of the user equipment. However, satellite coverage is not always available due to orbiting patterns and schedules of low-Earth orbit satellites. A satellite constellation may pass over the location of the remotely located user equipment only infrequently. However, if the user equipment is consistently monitoring for the presence of the satellites, the user equipment may drain the battery which powers the user equipment.

### BRIEF DESCRIPTION OF THE DRAWINGS

Reference will now be made to the accompanying drawings, which are not necessarily drawn to scale, and wherein:

FIG. 1 is a block diagram illustrating an exemplary, non-limiting embodiment of a communications network in accordance with various aspects described herein.

FIG. 2A is a block diagram illustrating an example, non-limiting embodiment of a system functioning within the communication network of FIG. 1 in accordance with various aspects described herein.

FIG. 2B illustrates an exemplary embodiment of a communication system in accordance with various aspects described herein.

FIG. 2C illustrates an exemplary embodiment of a model of non-terrestrial coverage in a communication system such as the communication system of FIG. 2A, in accordance with various aspects described herein.

FIG. 2D depicts an illustrative embodiment of a method in accordance with various aspects described herein.

FIG. 3 is a block diagram illustrating an example, non-limiting embodiment of a virtualized communication network in accordance with various aspects described herein.

FIG. 4 is a block diagram of an example, non-limiting embodiment of a computing environment in accordance with various aspects described herein.

FIG. 5 is a block diagram of an example, non-limiting embodiment of a mobile network platform in accordance with various aspects described herein.

FIG. 6 is a block diagram of an example, non-limiting embodiment of a communication device in accordance with various aspects described herein.

### DETAILED DESCRIPTION

The subject disclosure describes, among other things, illustrative embodiments for using user equipment devices attached to a cellular communication network as sensors to detect satellite presence at any given point and then to use aggregated presence data to predict where satellite coverage will be available to user equipment in areas outside the coverage of the cellular network for direct-to-satellite communication. Other embodiments are described in the subject disclosure.

One or more aspects of the subject disclosure include receiving from a plurality of user equipment (UE) devices in communication with a terrestrial network, information about coverage by a non-terrestrial network in a current coverage area of the non-terrestrial network, predicting future coverage areas of the non-terrestrial network, wherein the predicting is based on the information about the coverage by the non-terrestrial network in the current coverage area, and providing coverage information about predicted future coverage areas to remote UE devices in areas with no coverage from the terrestrial network, the coverage information enabling the remote UE device to connect to the non-terrestrial network when the coverage by the non-terrestrial network becomes available for the remote UE devices.

One or more aspects of the subject disclosure include receiving, from a plurality of user equipment (UE) devices, sensor information about a presence of satellite coverage of a non-terrestrial network at respective locations of respective UE devices, modeling a configuration of a coverage area of the satellite coverage, wherein the modeling is based on the sensor information, receiving, from a remote UE, information about a current location of the remote UE, the remote UE in communication with the non-terrestrial network, and providing, to the remote UE, coverage information for future satellite coverage of the non-terrestrial network, the coverage information to enable the remote UE to schedule low-power operations during times when the future satellite coverage of the non-terrestrial network is not available at the current location of the remote UE.

One or more aspects of the subject disclosure include receiving sensor information from a plurality of user equipment (UE) devices attached to a cellular network, the sensor information determined by a respective UE device based on a presence of satellite coverage of a non-terrestrial network detected by the respective UE device at a respective location of the respective UE device, predicting future coverage areas for the satellite coverage of the non-terrestrial network, wherein the predicting future coverage areas is based on the sensor information, and providing, to a remote UE in an area with no coverage from the cellular network, information about future coverage areas and future coverage times for the satellite coverage of the non-terrestrial network to enable the remote UE to schedule future network access with the non-terrestrial network.

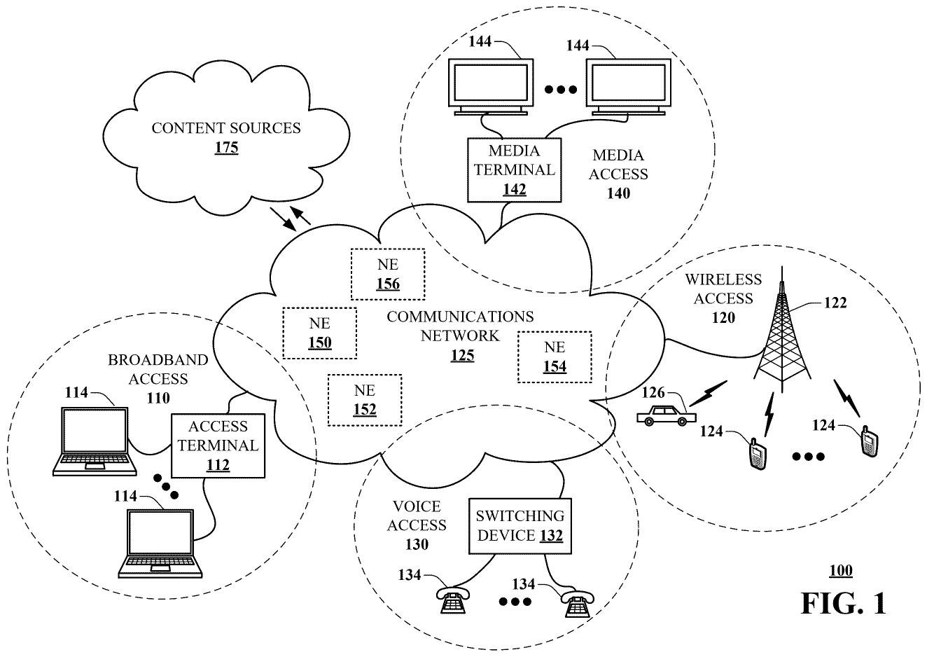

Referring now to FIG. 1, a block diagram is shown illustrating an example, non-limiting embodiment of a system 100 in accordance with various aspects described herein. For example, system 100 can facilitate in whole or in part receiving sensor data from user equipment devices on a cellular network that sense pilot signals from orbiting satellites, predicting where future satellite coverage will be available, and providing the prediction to user equipment devices in locations where the cellular network is not available. In particular, a communications network 125 is presented for providing broadband access 110 to a plurality of data terminals 114 via access terminal 112, wireless access 120 to a plurality of mobile devices 124 and vehicle 126 via base station or access point 122, voice access 130 to a plurality of telephony devices 134, via switching device 132 and/or media access 140 to a plurality of audio/video display devices 144 via media terminal 142. In addition, communication network 125 is coupled to one or more content sources 175 of audio, video, graphics, text and/or other media. While broadband access 110, wireless access 120, voice access 130 and media access 140 are shown separately, one or more of these forms of access can be combined to provide multiple access services to a single client device (e.g., mobile devices 124 can receive media content via media terminal 142, data terminal 114 can be provided voice access via switching device 132, and so on).

The communications network 125 includes a plurality of network elements (NE) 150, 152, 154, 156, etc. for facilitating the broadband access 110, wireless access 120, voice access 130, media access 140 and/or the distribution of content from content sources 175. The communications network 125 can include a circuit switched or packet switched network, a voice over Internet protocol (VoIP) network, Internet protocol (IP) network, a cable network, a passive or active optical network, 2G (i.e., GSM network), a 3G, 4G, 5G, or higher generation wireless access network, WIMAX network, UltraWideband network, personal area network or other wireless access network, a broadcast satellite network and/or other communications network.

In various embodiments, the access terminal 112 can include a digital subscriber line access multiplexer (DSLAM), cable modem termination system (CMTS), optical line terminal (OLT) and/or other access terminal. The data terminals 114 can include personal computers, laptop computers, netbook computers, tablets or other computing devices along with digital subscriber line (DSL) modems, data over coax service interface specification (DOCSIS) modems or other cable modems, a wireless modem such as a 4G, 5G, or higher generation modem, an optical modem and/or other access devices.

In various embodiments, the base station or access point 122 can include a 4G, 5G, or higher generation base station, an access point that operates via an 802.11 standard such as 802.11n, 802.11ac or other wireless access terminal. The mobile devices 124 can include mobile phones, e-readers, tablets, phablets, wireless modems, and/or other mobile computing devices.

In various embodiments, the switching device 132 can include a private branch exchange or central office switch, a media services gateway, VoIP gateway or other gateway device and/or other switching device. The telephony devices 134 can include traditional telephones (with or without a terminal adapter), VoIP telephones and/or other telephony devices.

In various embodiments, the media terminal 142 can include a cable head-end or other TV head-end, a satellite receiver, gateway or other media terminal 142. The display devices 144 can include televisions with or without a set top box, personal computers and/or other display devices.

In various embodiments, the content sources 175 include broadcast television and radio sources, video on demand platforms and streaming video and audio services platforms, one or more content data networks, data servers, web servers and other content servers, and/or other sources of media.

In various embodiments, the communications network 125 can include wired, optical and/or wireless links and the network elements 150, 152, 154, 156, etc. can include service switching points, signal transfer points, service control points, network gateways, media distribution hubs, servers, firewalls, routers, edge devices, switches and other network nodes for routing and controlling communications traffic over wired, optical and wireless links as part of the Internet and other public networks as well as one or more private networks, for managing subscriber access, for billing and network management and for supporting other network functions.

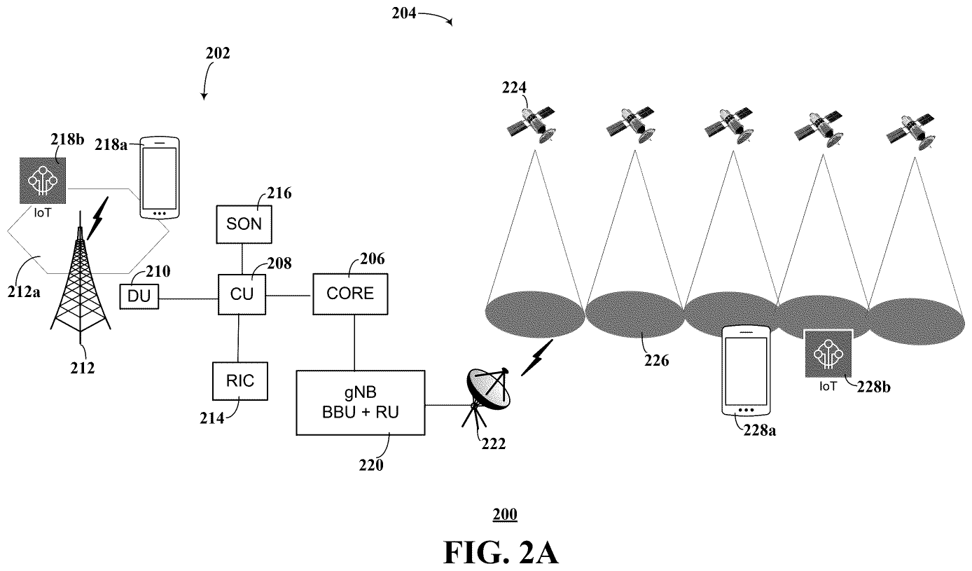

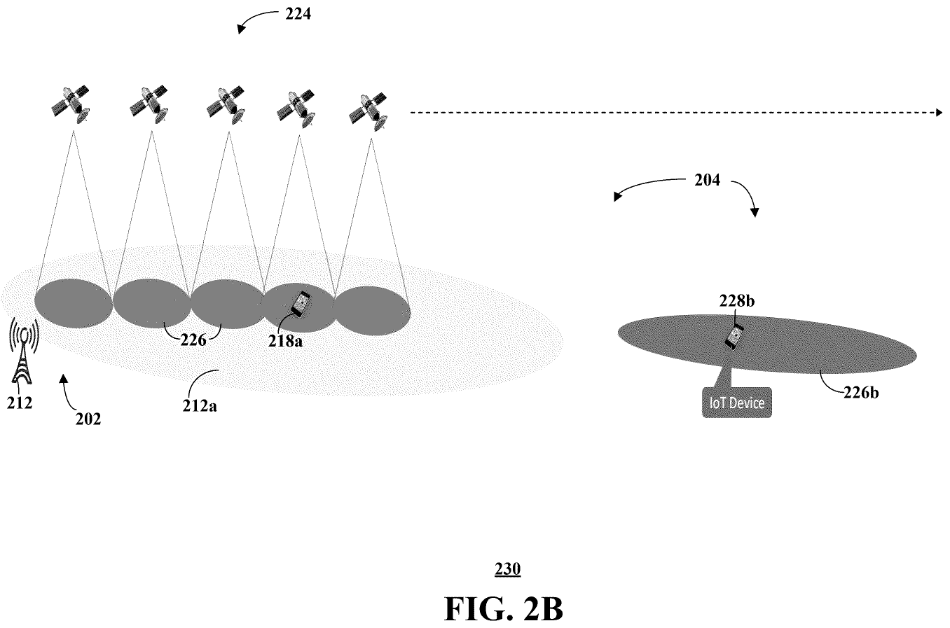

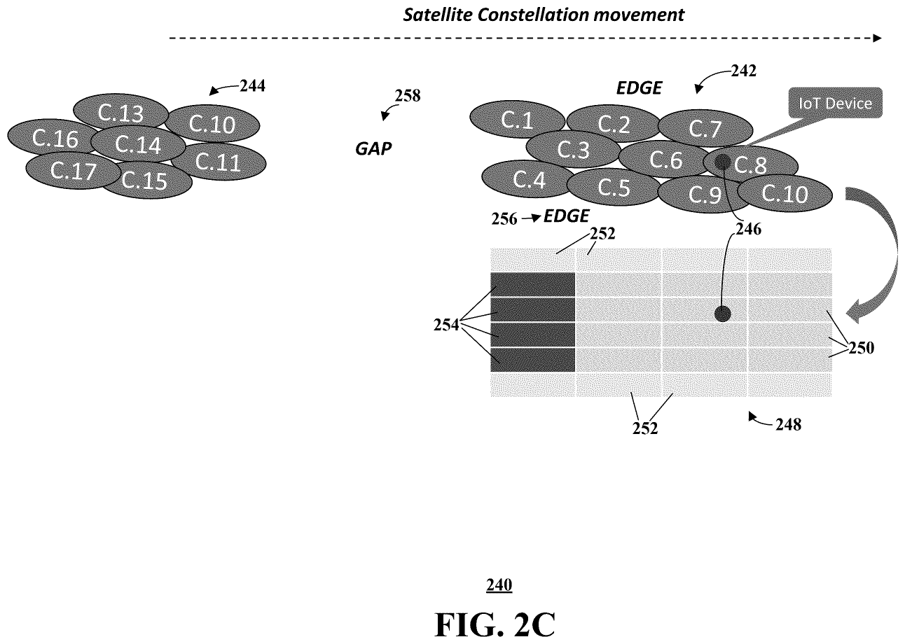

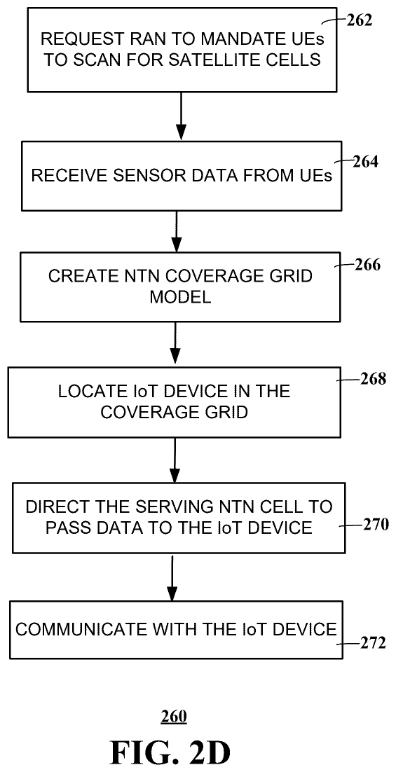

FIG. 2A is a block diagram illustrating an example, non-limiting embodiment of a system 200 functioning within the communication network of FIG. 1 in accordance with various aspects described herein. The system 200 includes a cellular network 202 and a satellite network 204. The cellular network 202 may be termed a terrestrial network (TN). Similarly, the satellite network 204 may be termed a non-terrestrial network (NTN). In embodiments, the cellular network 202 may be owned and operated by a mobile network operator (MNO), also referred to as a cellular service provider (CSP). The CSP may also operate the satellite network 204 or may partner with a separate organization operating the satellite network 204. The cellular network 202 and the satellite network 204 may cooperate to provide communication services to the same group of users. A user's device, or user equipment (UE), may communicate with the cellular network 202 and the satellite network 204, depending on network availability for the location of the UE.

The cellular network 202 in the exemplary embodiment includes a core network 206, one or more centralized units such as centralized unit (CU) 208, one or more distributed units such as distributed unit (DU) 210, one or more radio units (RU) 212, a radio access network (RAN) intelligent controller (RIC) 214, and a self-organizing network (SON) 216. Other embodiments of cellular networks will have additional or alternative components.

The core network 206 provides a variety of centralized functions for the cellular network 202. Such functions may include mobility management, accounting and authorization and others. Further, the core network 206 may include one or more gateways to other networks such as the public internet and the satellite network 204.

The CU 208 handles control plane functions of the cellular network 202. These functions may include user session management, resource allocation, mobility management and others. The CU 208 communicates with the core network 206, distributed units such as DU 210 and other network elements to exchange information to manage radio resources, user sessions and user data.

The DU 210 handles user plane functions of the cellular network 202 including processing data traffic and managing radio resources. The DU 210 manages radio resources such as the RU 212. The DU 210 operates as a baseband unit (BBU) to process baseband communication signals between the RU 212 and the CU 208, including both uplink (UL) and downlink (DL) signals. The uplink is the radio connection from a device such as the user equipment (UE) 218a and internet of things (IoT) device 218b to the RU 212; the downlink is the radio connection from the RU 212 to the UE 218a or IoT device 218b. The DU 210 in combination with one or more RUs such as RU 212 establishes a radio access network for access by a subscriber unit or user equipment (UE) such as UE 218a or IoT device 218b. The RU 212 provides communications services to a coverage area 212a near the RU 212 for UEs such as the UE 218a or IoT device 218b in the coverage area 212a.

UEs such as the UE 218a and IoT devices such as the IoT device 218b may be collectively referred to as UE. An IoT device generally is a physical object that can connect to communication networks including the internet and exchange data. IoT devices often have sensors, software, and other technologies embedded in them, allowing them to collect, process, and transmit information. Examples of IoT devices include smart home devices such as thermostats and security cameras, industrial sensors, connected vehicles and wearable devices such as smart watches and medical devices.

The RU 212 is in radio communication with radio devices such as the UE 218a or IoT device 218b, other user equipment, and others. The RU 212 may include or be part of an eNodeB in a fourth generation (4G, or long-term evolution, LTE) cellular network or a gNodeB in a 5G, 6G, or later cellular network. The RU 212 operates according to an air interface standard such the standards published by the 3^{rd} Generation Partnership Project (3GPP; 3GPP is a registered trademark of the European Telecommunication Standards Institute). User devices such as the UE 218a and IoT device 218b may attach to the cellular network 202 by initiating communication with the RU 212. The RU 212 and similar RUs provide user mobility by handing off radio communications with the UE 218a or the IoT device 218b from the RU 212 to another RU in the cellular network or to another target such as a satellite of the satellite network 204.

The RIC 214 manages and optimizes various function for the RAN. The RIC 214 may be divided into real-time and near-real-time functions. The non-real-time RIC is part of the CSP's service management and orchestration (SMO) framework. In this role, the non-real-time RIC enables control of RAN elements and their resources. The near-real-time RIC enables actions and functions in the RAN that take, for example, 10 ms to 1 second to complete.

The SON 216 cooperates with other components of the cellular network 202 to improve network performance. In one example, the SON 216 operates to adjust radio frequencies used by different network elements to minimize interference, improve coverage and network capacity. In some embodiments, the SON 216 implements artificial intelligence (AI) or machine learning (ML) processes to manage network operation based on collected data about the network and network operation.

The UE 218a and the IoT device 218b may be any mobile or portable radio device or IoT device capable of communicating with the cellular network 202 and the satellite network 204. In general, the UE 218a and the IoT device 218b communicate on one or more frequency bands and operate under control of the cellular network 202. The cellular network 202 may be a fifth generation (5G) cellular network or later modification or enhancement, such as a sixth generation (6G) cellular network. The UE 218 may communicate with the 5G, 6G and other network technologies.

The cellular network 202 may cooperate with the satellite network 204 to provide communication services to UEs such as the UE 218a, the IoT device 218b, UE 228a and IoT device 228b. The satellite network 204 includes terrestrial equipment such as gateway 220 and one or more ground stations such as ground station 222, along with one or more satellites 224. Other embodiments of the satellite network 204 may include additional or alternative elements and functions. The embodiment of FIG. 2A is intended to be exemplary only.

The gateway 220 in the illustrated example is in data communication with the core network 206 of the cellular network 202. The ground equipment provides many of the same functions as CU 208, DU 210, RU 212, RIC 214 and SON 216. The gateway 220 may include or provide functions of a gNodeB or gNB as well as a baseband unit (BBU) and RU in a terrestrial network such as cellular network 202.

The gateway 220 is also in in data communication with ground station 222. The ground station 222 communicates via radio signals with Earth orbiting satellites such as satellites 224. In turn, the satellites 224 communicate with one or more UEs such as UE 228a and IoT device 228b.

The satellites 224 are in generally low Earth orbit. Typical altitude for the satellites 224 is 500 to 700 km. In some embodiments, the satellites 224 travel in a cluster or constellation of more than one satellite. The satellites 224 provide communication services to a service area 226 on the surface of the earth. In the example, the service area 226 for each satellite is illustrated as being generally round in shape. However, the service area may have any suitable shape or configuration depending on terrain, angle of arrival at the earth's surface and conditioning or shaping of the transmitted beam or received beam at the satellites 224.

A cellular service provider with a terrestrial cellular network (TN) such as the cellular network 202 may own or cooperate with a direct cellular-to-satellite non-terrestrial network such as the satellite network 204 in addition to the terrestrial network. A cellular-to-satellite non-terrestrial network (NTN) can create a direct connection from a conventional cellular telephone such as UE 228a or IoT device 228b of a customer or subscriber using LTE, 5G, GSM, UMTS, 6G, or other commercially available cellular technology User Equipment (UE) to a satellite such as satellites 224. The satellite must use frequency bands that the UE or IoT device is already designed to communicate with and must use either unlicensed bands or bands that are licensed to the CSP.

Satellite cells or coverage areas such as service area 226 may be used to provide additional coverage or capacity to terrestrial cells such as coverage area 212a. Satellite cells may have the ability to use one or more cells, and to operate at different frequency bands (i.e. band B5, in the 850 MHz band, and band B14 in the 700 MHz band). The CSP or wireless operator may have the ability to mandate satellite cells to change frequency bands to avoid interference with terrestrial cells, which may operate in the same frequency band. Thus, the CSP operating the cellular network 202 may manage radio resources of the satellite network 204 to provide reliable communications services.

In other examples, the CSP can use satellite cells to provide additional service capacity to specific areas at specific hours of the day. An example is the busy hour, or the time in the day when the cellular network experiences heaviest traffic loading. Also, the CSP may have the ability to change the coverage area of the satellite cells or schedule the coverage of the satellite cells in such a way that satellite cells or service areas 226 of the satellite network 204 serve the congested terrestrial RAN areas at their corresponding busy times to supplement coverage provided by the cellular network 202.

The CSP may be generally aware of the time and duration when the satellite cells or service areas 226 will cover or coincide with congested areas of the cellular network 202. The CSP or wireless operator is also aware of the frequency bands used in the terrestrial cells, and also is also aware of the capabilities of IoT devices and UEs such as UE 218a, IoT device 218b, UE 228a and IoT device 228b, and bands that these devices support. The CSP may use different frequency bands in different locations. Frequency bands are generally licensed by the CSP from an authority such as the US government. Other authorities in other jurisdictions may license other bands for use by the CSP.

As illustrated in the example of FIG. 2A, the operator of the satellite network 204 may deploy several satellites in a batch or constellation. In the example of FIG. 2A, a constellation of satellites 224 includes five satellites travelling together in low earth orbit. Each satellite provides two-way communication services to a service area or satellite cell or service area 226. Each satellite cell may have a predefined coverage area such as service area 226. In an example, the coverage area is generally round in shape with a radius on the Earth's surface of approximately 50 km. Satellite cells or coverage areas or service areas may be arranged in a specific formation to provide continuous coverage to terrestrial UEs. For example, if the satellites 224 in FIG. 2A are in low Earth orbit and moving from left to right in the drawing figure, the coverage area including the five contiguous service areas 226 moves from left to right as well. The service areas 226 may be linked to cooperate and provide cellular service to a UE such as UE 228, IoT devices and other devices. A constellation of satellite cells can provide larger continuous coverage based on the number of satellite cells in the group.

The CSP or satellite operator may have several batches of satellite cells. This batches may have gaps in between. Therefore, there may be times in which terrestrial UEs and IoT devices will not detect any satellite cell or service area 226. In an example, an IoT device such as the IoT device 228b may be placed in a remote area lacking reliable cellular coverage, such as a forest or in the middle of the ocean. The IoT device 228b is powered by a depletable energy source such as a battery. The IoT devices may be tasked with certain automated functions. For example, the IoT devices may be used to report certain conditions periodically back to the ground controller station, such as a temperature or humidity reading, reported once or twice a day, or every 4 hours. The IoT device will not have access to terrestrial coverage from the cellular network 202. The satellite network 204 and satellite cells are the only option for such IoT devices.

As noted, satellites 224 and satellite cells may be deployed in batches or constellations, i.e. N satellite cells placed near each other to provide larger or wider or contiguous coverage on the surface of the Earth. Satellite cell batches may pass over an IoT device such as IoT device 228b only every several hours. For example, a first constellation may pass during a time window from 8:00 to 9:30 A.M.; a second constellation may pass during a time window from 1;00 to 3:00 P.M; and a third constellation may pass during a time window from 10:00 to 11:00 P.M. IoT devices such as the IoT device 228b may try to connect and upload content to a satellite cell when the satellites 224 of the constellation are overhead. The attempt to transmit will be unsuccessful and will result in battery drainage. The IoT device 228b will deplete energy from the battery attempting to connect to satellite cell when the satellites 225 and their coverage areas or service areas 226 are not available. Published standards, such as 3GGP standards, do not provide guidance and recommendations for the UE 228a or the IoT device 228b to be aware of the presence of satellite cells and active coverage areas or service areas 226.

Thus, for the foreseeable future, coverage provided by such satellite constellations is not going to be fully continuous coverage. Coverage will be provided to a particular area of the surface of the Earth for a limited time while the constellation passes over the area. But then there may be gaps in the constellation overflight and in coverage during which there is no available satellite service. On the ground side of the radio channel, the IoT device 228b or the UE 228a have a cadence or a schedule on which they look for network coverage. The devices remain in a low power sleep mode, neither transmitting nor receiving. In response to a trigger such as the lapse of a timer, a device such as IoT device 228b wakes up, energizes its radio receiver and, if no coverage is found, the IoT device 228b goes back to sleep. It will wake up later to check for coverage. If this pattern of the IoT device 228b does not match up with when the satellites are overhead, each wake period is a missed opportunity creates a longer delay in when information can be passed from the IoT device 228b to its intended destination. On the other hand, if the IoT device 228b is programmed to power-up more frequently from the low power sleep mode to check for satellite coverage, then the battery that powers the IoT device 228b depletes more rapidly.

FIG. 2B illustrates an exemplary embodiment of a communication system 230 in accordance with various aspects described herein. In FIG. 2B, the communication system 230 includes a portion of cellular network 202 and a portion of satellite network 204 which are co-operated or provide complementary communication services to UE devices such as UE 218a and IoT device 228b. The UE 218a is in the service area or coverage area 212a associated with RU 212 of the cellular network. The UE 218a further is in the service area 226 of the satellites 224. The IoT device 228b is in an area 226b that may coincide in the future with the service area 226 of the satellites 224 depending on the motion of the satellites 224. The IoT device 228b is not in the coverage area 212a of the RU 212. The IoT device 228b can only rely on communication with the satellites 224 when the coverage areas or service areas 226 of the satellites coincides with the location of the IoT device 228b.

As indicated by the arrow in the drawing figure, the satellites 224 are moving low-Earth orbit from left to right. The exemplary embodiment of FIG. 2B displays a moment in time when the satellites 224 are passing over the UE 218a. The UE 218a may detect radio signals of the satellites 224 and relay information, over the cellular network 202, about the detected radio signals to a centralized modeling module, located at, for example, at the core network 206, a CU 208, a DU 210, a RIC 214 or a SON 216 (FIG. 2A) of the terrestrial network, cellular network 202. Thus, a network element such as a CU 208, DU 210, RIC 214 or SON 216 may obtain sensor information that is collected by UEs such as UE 218a. Moreover, the network element can share the information about pilot signals and other network information to other locations in the network. For example, one CU in a portion of the cellular network 202 may share information such as sensor information with a CU in a different portion of the network In the illustrated moment in time, the IoT device 228b awaits arrival of the satellites 224 overhead and the coverage areas or service areas 226 of the satellites 224.

The IoT device 228b includes a cellular radio that is configured for radio communication with the RU 212 of the terrestrial network and one or more of the satellites 224 of the non-terrestrial network when in range. The radio communication may be according to one or more air interface standards such as those published by 3GPP for the 5G, 6G and subsequent follow-on systems. Thus, the communication may be direct-to-satellite from the IoT device 228b to one or more satellites 224 using the 6G cellular standard, for example. The IoT device 228b may include other radio circuits such as a Wi-Fi transceiver for communication according to one of the IEEE 802.11x standards. The IoT device 228b may include a timer or other timing circuitry for timing its own operation and network operation as well.

In some embodiments, a system and method predict when non-terrestrial (i.e., satellite) coverage will be available for a UE or IoT or other device such as the IoT device 228b which is not in a terrestrial (i.e., cellular) coverage area and the device must rely on intermittent non-terrestrial coverage. The device may be any UE or IoT device that is configured to communicate on the terrestrial network, such as a mobile phone or IoT device configured for 5G, 6G or later cellular communication. The device may selectively communicate with the non-terrestrial network using the cellular radio of the device. Other devices, such as the UE 218a, attached to the terrestrial network, may report availability of coverage from constellations of satellites as they move overhead. The coverage reports may be sent to a centralized modeling module, located at, for example, at the core network 206, RIC 214 or SON 216 of the terrestrial network (FIG. 2A).

The modeling module may estimate or predict non-terrestrial coverage as well as gaps in non-terrestrial coverage. The non-terrestrial coverage includes the coverage areas or service areas 226 of the satellites 224, which is dynamically in motion across the Earth's surface due to the motion of the satellites 224. The modeling module may estimate the likelihood of detecting a satellite cell signal at a particular location for a particular UE or IoT such as IoT device 228b which has no terrestrial coverage available (such as in a remote desert or forest area, or at sea).

The illustrated constellation of satellites may be one such constellation of several or many such constellations which cooperate to provide communication services to terrestrial devices such as the UE 218a and the IoT device 228b while orbiting the Earth. There may exist gaps between individual adjacent constellations. Further, there may be service gaps between the respective service areas of the respective constellations. The modeling module may further estimate one or more gap durations for areas where terrestrial cell coverage is not available and only satellite coverage is available. The gap duration corresponds to the amount of time a terrestrial device such as the IoT device 228b is in a position corresponding to a service gap between service areas of respective constellations.

The estimate or prediction produced by the modeling module includes a tolerance or approximation or element of likelihood because of degrees of randomness in the system. For example, the satellites are orbiting the Earth, and their location and direction is known, but a coverage area provided by a constellation of satellites may have somewhat indeterminate edges due to radio interference or earthly topography, for example. Still further, the UE or IoT may not be located directly in the center of a coverage region but at an edge thereof. Further, the UE or IoT in the non-terrestrial coverage area may be moving. The device may be carried by a human through an area, or it may be attached to a moveable object, so that its precise location is not known to the system and the modeling module. These factors create some imprecision and thus the prediction is only a likelihood of the geometry and timing of a moving coverage area.

FIG. 2C illustrates an exemplary embodiment of a model 240 of non-terrestrial coverage in a communication system such as the communication system 200 of FIG. 2A, in accordance with various aspects described herein. In accordance with FIG. 2C, non-terrestrial coverage is modeled based on observations collected from terrestrial UEs located in coverage areas of a terrestrial network and based on the actual reported location of IoT devices.

Information about locations may be reported to a central location such as a modeling module. The modeling module may include software, hardware or a combination of both. The modeling module may be located at any suitable location which has communication access with network elements such as radio units, distributed units and centralized units of a terrestrial communication system, as well as information about satellites and constellations of satellites of a non-terrestrial network. For example, the modeling module may reside at the core network 206, at the RAN, or behind the eNB. i.e. at the SON 216 or RIC 214.

The communication system 230 of FIG. 2C may implement in model 240 a methodology for estimating non-terrestrial cell coverage and gaps based on observations from terrestrial UEs. The methodology uses one or more prediction models to estimate the likelihood of detecting a satellite cell signal and the gap duration for areas where terrestrial cell coverage is not available and only satellite coverage is available. Through implementation of this methodology, draining the UE battery may be avoided during terrestrial UEs attempt to search for satellite cells when the satellites are not available.

In accordance with the methodology, UEs located in urban areas or other areas with access to both a terrestrial network and a non-terrestrial network may be used as sensors to detect satellite coverage. They may be termed sensor UEs. As a constellation of satellites passes overhead of a sensor UE connected to a cell of the terrestrial network, the sensor UE detects signals transmitted by the satellite. Any transmitted signal such as broadcast channels, synchronization signals, etc. These may generally be termed pilot signals. The satellites, operating according to, for example the 6G standard, transmit conventional signals intended for access by a UE. A UE seeking to attach to the satellite may respond with an appropriate access message. However, the sensor UE which is connected to a gNodeB of the cellular network, operates only as a sensor UE, detecting the pilot signals from one or more satellites without attempting to attach to the satellites.

The sensor UE may detect any suitable information as the pilot signal. In embodiments, the sensor UE may detect, for example, the physical cell identity (PCI) of a received signal. The PCI is a unique identifier assigned to each individual cell in a cellular network, such as 5G, 6G and direct to satellite cellular networks. The sensor UE may further detect other signal qualities such as a radio signal strength indicator (RSSI) value. Any suitable information may be collected and reported by the sensor UE to the modeling module, along with, for example, the current location (GPS coordinates or otherwise) of the sensor UE.

If a constellation of satellites passes overhead, the sensor UE may receive pilot signals from multiple satellites or all satellites of the constellation. Each satellite has its own identity information which is broadcast on an access channel for use by UEs seeking to attach. This identity information from a pilot signal may be collected by multiple sensor UEs. This information collection process may be done in the background of normal operation of the sensor UE and the user associated with the sensor UE may have no awareness of the process. Suitable permissions should be obtained from the user.

These sensor UEs report back to the modeling module satellite cell coverage with respect to the corresponding sensor UE location. The sensor UE may determine its location in any suitable manner, such as through use of a Global Positioning System (GPS) receiver on board the sensor UE. In embodiments, the sensor UE communicates that it detects the pilot signal from a satellite 224 and the duration during which it detects the pilot signal. Typically, the duration is about 5 minutes. Since the first constellation 242 is moving in the direction to the right in FIG. 2C, the sensor will detect multiple pilot signals, one from each satellite of the constellation. The sensor UE will report the detected pilot signals and the duration of detection. Finally, once the first constellation 242 moves past the sensor UE, the sensor UE will detect no pilot and will report a gap in the service area or coverage from satellites.

Information about the reported pilot signals from the sensor UE, is conveyed over the network to the modeling module. Any suitable communication technique may be used. For example, an application may be instantiated on a network device such as the SON 216 or the RIC 214 (FIG. 2A) and operated to control the modeling module and communications between a group of sensor UEs and the modeling module. Under control of the application, the sensor UEs of the group of sensor UEs each detect pilot signals from satellites of multiple constellations of satellites. For example, if the first constellation 242 is moving from west to east over the sensor UE, a second sensor UE located near the sensor UE but to the south will detect some of the pilot signals from the satellites of the first constellation, but not all. The sensor UE will report the detected pilot signals to the modeling module.

The modeling module creates one or more models to predict the satellite cell coverage for UEs (such as an IoT device) that do not have terrestrial coverage. For example, the modeling model collects information about detected pilot signals from all reporting sensor UEs and compiles a coverage model for satellite coverage of the non-terrestrial network. Any suitable expression or definition of the coverage model may be developed. In general, the coverage model includes information about the constellation and the satellite coverage area, its direction of travel and speed, its width, such as 25 km. The model may include any other suitable information, such as the number of satellites in the constellation, the density of satellites in the constellation, and the physical size of the constellation and its coverage area.

Subsequently, when the second constellation 244 passes over, the process is repeated. The sensor UEs will detect a gap in coverage between the two constellations and may report the duration of the gap. In other examples, the modeling module may note the gap in reported pilot signals from the sensor UEs and thus identify the gap in coverage in that manner. The modeling module will collect sensor information from the sensor UEs to develop a model of the size and shape and movement of satellite coverage areas for the non-terrestrial network.

Satellite coverage is very dynamic in nature. Coverage is constantly changing over time. The data generated by the sensor UEs can be very large in size, coming from a large number of UEs on the ground as time series data. This time series data or other sensor data may be provided to an artificial intelligence (AI) or machine learning (ML) model, collectively, and AI/ML process for development of the coverage model. The AI/ML process may derive the path of a particular coverage area, including direction and speed and size of the coverage area. Further, the AI/ML process can predict coverage in the near term, such as 12 to 24 hours in advance. For longer terms, prediction may not be as accurate due to degradation of orbits, maintenance activities that take one or more satellites offline, and other reasons. The prediction may then be used to advise an IoT device in a remote area about when it should look for a passing constellation.

FIG. 2C illustrates two constellations of satellites in motion according to the arrow at the top of the drawing figure, from left to right in the figure. The first constellation 242 creates satellite cells having coverage areas labelled C.1 through C.10. A second constellation 244 includes or is associated with satellite cells having coverage areas labelled C.11 through C.13. Any number of constellations, each including any number of satellites or satellite cells, may be implemented. The model 240 of FIG. 2C is intended to be exemplary only.

Based on information received from sensor UEs, the modeling module develops a model of satellite constellation coverage for each constellation. FIG. 2C illustrates a grid 248 that models satellite coverage for the first constellation 242. The grid 248 and the first constellation 242 are shown in conjunction with an IoT 246. Portions of the grid 248 may be designated in any suitable manner. In the example of FIG. 2C, the grid 248 is divided into a plurality of quadrants. In the example, quadrants are all the same size but in other examples, variable-sized quadrants may be used. Moreover, in the example, the quadrants are all rectangular. In other example, other shapes may be used such as hexagons.

In FIG. 2C, quadrants 250 indicate that the IoT 246 is in the middle of the non-terrestrial constellation coverage area. Quadrants 252 along the edge indicate that the IoT 246 is at the edge of the non-terrestrial constellation coverage area. Quadrants 254 indicate that the IoT 246 is about to exit the non-terrestrial constellation coverage area. The quadrants indicate the presence or absence of a signal that the IoT 246 can use to communicate with a satellite. Thus, if the IoT 246 is in one of quadrants 250, the IoT 246 has good coverage. If the IoT 246 is in one of quadrants 252, the IoT 246 is at the edge 256 of the coverage area and may be about to lose signal from the satellite. Beyond the edge quadrants 252, there is no coverage. If the IoT 246 is in quadrants 254, the IoT 246 has coverage but is about to be outside the coverage area as the coverage area moves with the first constellation 242 of satellites from left to right. Once the coverage area has moved to the right with the satellites, the IoT 246 will experience a gap 258 in coverage area. Thus, the model 240 forms a prediction about what is to happen to coverage experienced by the IoT 246.

The different quadrants may be described or illustrated in different fashions. In one example, a color coding is used for good-coverage quadrants 250, for edge quadrants 252 and for about-to-exit quadrants 254. In another example, a numerical value from 0 to 1 is indicative of a likelihood of coverage. For example, a numerical value of 1 may be provided for good-coverage quadrants 250 in the middle part of the coverage area, a value of 0.5 may be used for edge quadrants 252, and a value of 0.1 may be used for about-to-exit quadrants 254.

The IoT 246, when communicating with the satellite, may associate the likelihood of coverage value or indicator for its particular location with an urgency for communication. As the IoT 246 enters the about-to-exit quadrants 254 from the good coverage quadrants 250, the IoT 246 becomes aware that the communication window with the satellite, when a satellite of the first constellation 242 is present overhead, is about to close. In embodiments of the model 240, each quadrant or area of the grid is assigned a likelihood of coverage that the IoT 246 may use to determine the availability of coverage.

FIG. 2D depicts an illustrative embodiment of a method 260 in accordance with various aspects described herein. The method 260 may be used to estimate and notify terrestrial UEs about satellite cell coverage for a direct-to-satellite radio communication system. The method 260 enables UEs (including IoT devices) to predict large coverage gaps. The method 260 enables the UE to avoid unduly draining the battery which provides operating power to the UE if terrestrial UEs attempt to search for satellite cells when the satellite cells are not available. The method 260 may be performed at any suitable network location that has access to communications and data from UE devices attached to the terrestrial network and access to communication with UE devices attached to the non-terrestrial network. In some embodiments, the method 260 may be implemented by a modeling module in accordance with the description herein. The method 260 may be initiated by any suitable input, such as a determination that one or more UE or IoT devices is located with no terrestrial network access and with only intermittent non-terrestrial network access.

At step 262, the method 260 includes requesting the radio access network (RAN) of the terrestrial network to mandate or direct UEs attached to the terrestrial network to scan for satellite cells. A UE is attached to the network when it has established a connection with the network to access services. Attachment man include scanning for available terrestrial or non-terrestrial cells, initiating a radio resource control (RRC) request to a cell the UE wants to attach to, authentication of the UE on the network, and service activation. Other processes may be involved as well for attached UEs.

In an example embodiment, the RAN may install or activate a sensor application on some or all UEs in some or all areas. The sensor application may cause the UEs to begin scanning designated frequency bands for pilot signals transmitted by satellites that are part of the non-terrestrial network. The UEs may collect any suitable information about the pilot signals, such as received signal strength and physical cell identity (PCI) for the pilot signal. Further, the UEs may report information about the pilot signals to the modeling module or other destination for storage and processing. The reported information may be termed sensor data, as the UEs are in effect being used as sensors to detect satellite presence at any given point. The sensor application may run in the background on the UE and may use conventional radio frequency (RF) circuitry of the UE that is normally used for communication, for example, a 5G or 6G or similar cellular network.

In some embodiments, only UEs in urban areas are activated in this manner to scan for satellite pilot signals. By using densely located UEs and mobile UEs, a more complete data set may be obtained. For example, more data may be received and processed for more UE locations, especially UE locations that are relatively close to each other, in order to develop a more finely grained picture of a coverage area for each satellite and each constellation. A more detailed picture of the edges and perimeter of the coverage area of a satellite constellation may be developed by collecting more sensor data.

At step 264, the method 260 includes receiving the sensor data at the modeling module. In embodiments, the sensor data is time series data including a time stamp and identification of the satellite such as by PCI detected at the time corresponding to the time stamp, along with location information for the reporting UE. Location information may be latitude-longitude coordinates or GPS coordinates or any other type of locating information. In some embodiments, additional data may be reported with the sensor data, such as a received signal strength detected by the UE from the satellite. The data may be quite large in volume and may be stored in any suitable manner. The data may be processed or conditioned in any suitable manner. In particular, the data may be formatted to form an input to an AI/ML process in order to predict an estimate of the likelihood of satellite cell coverage area location and duration, and the gap duration between such coverage areas.

Any suitable AI/ML process may be used to predict the satellite cell coverage area location and duration. In some embodiments, a large language model (LLM) may be used to receive text inquiries about coverage areas and provide responses to the queries in a suitable format. The LLM or other AI/ML process may be trained in any suitable manner with appropriate training data.

At step 266, the method 260 includes creating a non-terrestrial network grid model. An example coverage grid 248 is shown in FIG. 2C. In some embodiments, each quadrant of the coverage grid has associated therewith a number of parameters. These may include, for example, a likelihood of coverage (LC), a proximity to Constellation Edge (CE), a Proximity to GAP (PG), and a GAP Duration (GD). The gap represents a space between adjacent coverage areas of different satellite constellations. Coverage from one satellite cell can create one or more quadrants.

At step 268, the method 260 includes locating a UE or IoT in one of the grid model quadrants. In general, the UE or IoT is a device configured for radio communication on the terrestrial cellular network and the non-terrestrial satellite network. In some examples, the UE includes a smartphone or cell phone operative for voice and data communication. In other examples, the IoT includes a sensor for measuring a parameter and converting the parameter to data for transmission to a remote location. The UE or IoT device is generally located where there is no or limited cellular or terrestrial network coverage so that the UE or IoT device must rely on non-terrestrial or satellite coverage, which is intermittent at that location due to less-than-universal satellite coverage.

The modeling module or other processing system may receive from the non-terrestrial network information about the location of the UE or IoT. For example, the UE or IoT may include a GPS receiver for determining its location based on received GPS signals and report the determined location to the non-terrestrial network. The location of the UE or IoT may be matched with location information of the coverage grid to identify a quadrant of the coverage grid in which the UE or IoT is located.

At step 270, the method 260 directs the non-terrestrial network including a current serving cell to pass to the UE or IoT information about the parameters associated with the grid quadrant identified for the UE or IoT. In accordance with the embodiments described above, this data may include some or all of the likelihood of coverage (LC), the proximity to Constellation Edge (CE), the Proximity to GAP (PG), and the GAP Duration (GD) for the quadrant of the coverage grid model in which the UE or IoT is located. This information is unique for each UE and IoT device in the non-terrestrial network coverage area. This information can be sent to the UE or IoT devices as a customized system information block (SIB) message or any other type of over the air (OTA) messaging.

At step 272, the method 260 includes communicating with the UE or IoT device. Such communication occurs during a time when the UE or IoT device is within a coverage area of the non-terrestrial network. Such communication is interrupted or discontinued when the UE or IoT device is in a coverage gap, between coverage areas.

The IoT 246 may use the information about coverage areas and durations, as well as gap times and durations, to plan transmissions of data or other information to satellites of the non-terrestrial network. For example, the proximity to Constellation Edge (CE) parameter may be used by the UE or IoT device to identify how close the UE or IoT device is to the edge of the coverage area provided by the satellite constellation. Further, if the UE or IoT is movable, the UE or IoT device may use the CE parameter to direct movement to avoid the constellation edge so that connection and communication to the satellite may be maintained as long as possible. In an example, the UE device is a smartphone with a user interface including a display and keypad. The UE may evaluate the CE parameter, the current location of the UE (determined by an onboard GPS receiver, for example), and the trajectory of the current motion of the UE (based on multiple GPS values) and provide to the display a warning for the user to move no further in a particular direction, where the particular direction corresponds to the edge of the coverage area. In another example, the UE may provide a warning to the user to affirmatively move in another direction, toward the center of the coverage area.

In another example, if the UE or IoT device receives a high likelihood to reach a Proximity to GAP (PG), then the UE or IoT device is aware that it is about to exit the non-terrestrial coverage area. The device then knows that it should complete any transmissions and prepare to go into a low-power sleep mode for the time when coverage is not available.

In example embodiments, if the UE or IoT device is aware that coverage is about to end, the UE or IoT device can take appropriate actions to manage transmissions. For example, the UE or IoT device may switch to maximum transmission power to reduce bit error rate or other parameters and thereby reduce the number of retransmissions of data that may be required, to accelerate and complete the transmission. Similarly, the UE or IoT device may request a higher transmission priority from the network to reduce the amount of time required to complete a transmission before onset of the loss of coverage. Moreover, if the UE or IoT device detects a loss of coverage, the UE or IoT device is aware of the gap in coverage and its duration and therefore knows not to attempt to reconnect to the network. No coverage will be available until the passage of the next constellation.

In another example, the GAP Duration (GD) parameter may be used by the UE or IoT device to estimate the amount of time the UE or IoT device is going to be without non-terrestrial coverage. This relates to the amount of time in between adjacent satellite constellations. In embodiments, the UI or IoT device may set a timer, called “NO RECONNECT TIMER,” for example, to control the duration of the low-power sleep mode. The timer value may be set to the value of the GD Gap Duration parameter or similar value. Upon elapse of the timer, the UE or IoT wakes up to full power, energizes its radio circuit again and initiates contact with the network using a satellite of the next passing constellation.

In a further example, the model output parameters may be shared over the terrestrial network with other devices. A UE may be attached to the terrestrial RAN at a location and may be moving into a no-terrestrial-coverage area soon. The UE is thus an at-risk UE due to the risk of losing connection with the terrestrial network and having only intermittent coverage from the non-terrestrial network, but with no awareness of timing and availability of the satellite coverage. The modeling module and the method 260 may be adapted to include a process of detecting the location and the movement of the at-risk UE and sharing the satellite coverage information with the at-risk UE. With the satellite coverage information, the UE can transition from terrestrial coverage to non-terrestrial coverage when available, without a need to remain powered up searching for a cell and depleting the battery.

In another example of sharing model output parameters, the parameters and other information about predicted coverage areas from satellite constellations may be shared or populated into UE devices of various types and associated with a mapping application resident on the UE. In an example, a connected vehicle with a cellular radio on board may receive the information about predicted satellite coverage areas and may use the information when performing a coverage search. The information may be mapped and displayed on a user display of the vehicle to assist the vehicle operator.

In a further example, IoT or other devices may operate to move data into an area of better satellite coverage. In this example, a group of two or more UE or IoT devices are located in proximity to each other and cooperate to collect data using sensors and communicate the data over the network to an application at a remotely located server. The group of devices is in a remote area with no terrestrial coverage. The group of devices is in communication with each other, for example using Sidelink capability. 5G Sidelink is a feature within the 5G cellular network that allows devices to communicate directly with each other without involving the network infrastructure. This direct communication is known as Device-to-Device (D2D) communication. Sidelink allows the devices to cooperate in performing a task.

In the example, the cooperating devices share information about respective proximity to the edges of a satellite coverage area. For example, the model output parameters for each member of the group may be transmitted to each member of the group so that each member has awareness of the coverage situation of the other group members. In another example, each device receives its own parameters but is able to communicate with the other group members about its current and ongoing coverage situation.

In this example, then, the devices of the group are collecting data or performing other IoT functions and communicating the data to the satellite constellation while in the satellite constellation coverage area. Devices in edge coverage quadrants such as quadrants 252 and quadrants 254 in FIG. 2C may notify other group members of their edge status and that they are about to lose coverage. These edge devices may then communicate their collected data to group members that are still solidly in the coverage area, such as quadrants 250 in FIG. 2C. With better coverage in the center than at the edge of the coverage area, the devices in the center may be able to communicate faster, longer during the present coverage window. The same process may be applied if data is flowing from the network to the devices of the group. In effect, a wireless local area network may be established among the devices of the group and the group cooperates to route data to the group member with the best, longest lasting coverage before the coverage area passes the location.

While for purposes of simplicity of explanation, the respective processes are shown and described as a series of blocks in FIG. 2D, it is to be understood and appreciated that the claimed subject matter is not limited by the order of the blocks, as some blocks may occur in different orders and/or concurrently with other blocks from what is depicted and described herein. Moreover, not all illustrated blocks may be required to implement the methods described herein.

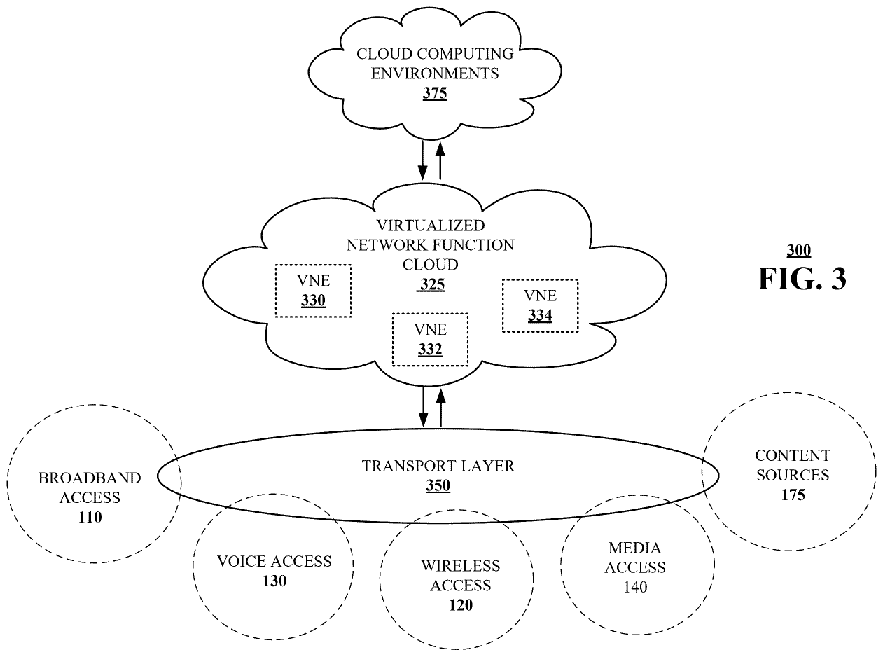

Referring now to FIG. 3, a block diagram is shown illustrating an example, non-limiting embodiment of a virtualized communication network 300 in accordance with various aspects described herein. In particular a virtualized communication network is presented that can be used to implement some or all of the subsystems and functions of system 100, the subsystems and functions of system 200, system 230, model 240 and method 260 presented in FIG. 1, FIG. 2A, FIG. 2B, FIG. 2C, FIG. 2D and FIG. 3. For example, virtualized communication network 300 can facilitate in whole or in part receiving sensor data from user equipment devices on a cellular network that sense pilot signals from orbiting satellites, predicting where future satellite coverage will be available, and providing the prediction to user equipment devices in locations where the cellular network is not available.

In particular, a cloud networking architecture is shown that leverages cloud technologies and supports rapid innovation and scalability via a transport layer 350, a virtualized network function cloud 325 and/or one or more cloud computing environments 375. In various embodiments, this cloud networking architecture is an open architecture that leverages application programming interfaces (APIs); reduces complexity from services and operations; supports more nimble business models; and rapidly and seamlessly scales to meet evolving customer requirements including traffic growth, diversity of traffic types, and diversity of performance and reliability expectations.

In contrast to traditional network elements—which are typically integrated to perform a single function, the virtualized communication network employs virtual network elements (VNEs) 330, 332, 334, etc. that perform some or all of the functions of network elements 150, 152, 154, 156, etc. For example, the network architecture can provide a substrate of networking capability, often called Network Function Virtualization Infrastructure (NFVI) or simply infrastructure that is capable of being directed with software and Software Defined Networking (SDN) protocols to perform a broad variety of network functions and services. This infrastructure can include several types of substrates. The most typical type of substrate being servers that support Network Function Virtualization (NFV), followed by packet forwarding capabilities based on generic computing resources, with specialized network technologies brought to bear when general-purpose processors or general-purpose integrated circuit devices offered by merchants (referred to herein as merchant silicon) are not appropriate. In this case, communication services can be implemented as cloud-centric workloads.

As an example, a traditional network element 150 (shown in FIG. 1), such as an edge router can be implemented via a VNE 330 composed of NFV software modules, merchant silicon, and associated controllers. The software can be written so that increasing workload consumes incremental resources from a common resource pool, and moreover so that it is elastic: so, the resources are only consumed when needed. In a similar fashion, other network elements such as other routers, switches, edge caches, and middle boxes are instantiated from the common resource pool. Such sharing of infrastructure across a broad set of uses makes planning and growing infrastructure easier to manage.

In an embodiment, the transport layer 350 includes fiber, cable, wired and/or wireless transport elements, network elements and interfaces to provide broadband access 110, wireless access 120, voice access 130, media access 140 and/or access to content sources 175 for distribution of content to any or all of the access technologies. In particular, in some cases a network element needs to be positioned at a specific place, and this allows for less sharing of common infrastructure. Other times, the network elements have specific physical layer adapters that cannot be abstracted or virtualized and might require special DSP code and analog front ends (AFEs) that do not lend themselves to implementation as VNEs 330, 332 or 334. These network elements can be included in transport layer 350.

The virtualized network function cloud 325 interfaces with the transport layer 350 to provide the VNEs 330, 332, 334, etc. to provide specific NFVs. In particular, the virtualized network function cloud 325 leverages cloud operations, applications, and architectures to support networking workloads. The virtualized network elements 330, 332 and 334 can employ network function software that provides either a one-for-one mapping of traditional network element function or alternately some combination of network functions designed for cloud computing. For example, VNEs 330, 332 and 334 can include route reflectors, domain name system (DNS) servers, and dynamic host configuration protocol (DHCP) servers, system architecture evolution (SAE) and/or mobility management entity (MME) gateways, broadband network gateways, IP edge routers for IP-VPN, Ethernet and other services, load balancers, distributers and other network elements. Because these elements do not typically need to forward large amounts of traffic, their workload can be distributed across a number of servers - each of which adds a portion of the capability, and which creates an elastic function with higher availability overall than its former monolithic version. These virtual network elements 330, 332, 334, etc. can be instantiated and managed using an orchestration approach similar to those used in cloud compute services.

The cloud computing environments 375 can interface with the virtualized network function cloud 325 via APIs that expose functional capabilities of the VNEs 330, 332, 334, etc. to provide the flexible and expanded capabilities to the virtualized network function cloud 325. In particular, network workloads may have applications distributed across the virtualized network function cloud 325 and cloud computing environment 375 and in the commercial cloud or might simply orchestrate workloads supported entirely in NFV infrastructure from these third-party locations.

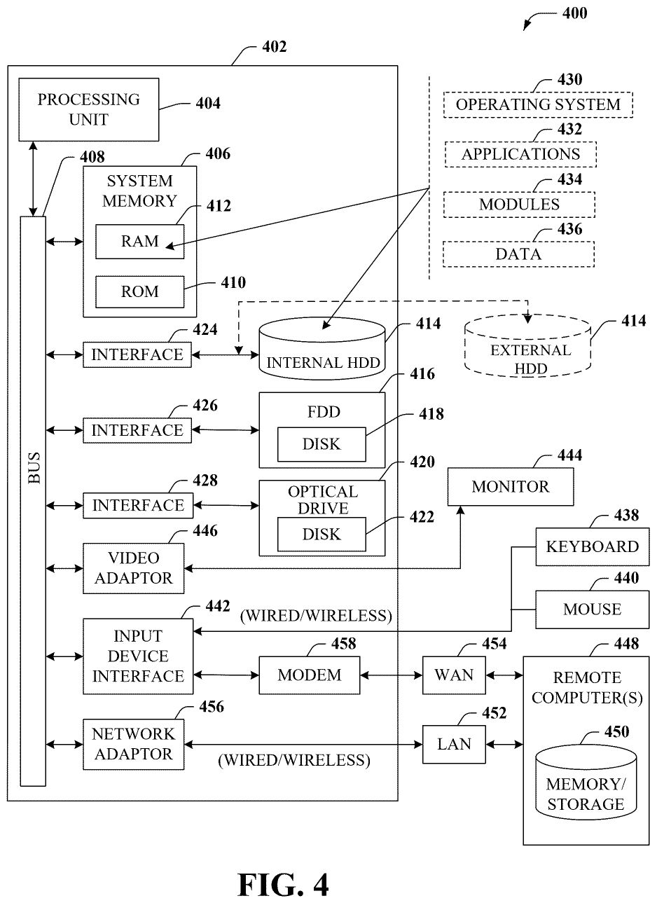

Turning now to FIG. 4, there is illustrated a block diagram of a computing environment in accordance with various aspects described herein. In order to provide additional context for various embodiments of the embodiments described herein, FIG. 4 and the following discussion are intended to provide a brief, general description of a suitable computing environment 400 in which the various embodiments of the subject disclosure can be implemented. In particular, computing environment 400 can be used in the implementation of network elements 150, 152, 154, 156, access terminal 112, base station or access point 122, switching device 132, media terminal 142, and/or VNEs 330, 332, 334, etc. Each of these devices can be implemented via computer-executable instructions that can run on one or more computers, and/or in combination with other program modules and/or as a combination of hardware and software. For example, computing environment 400 can facilitate in whole or in part receiving sensor data from user equipment devices on a cellular network that sense pilot signals from orbiting satellites, predicting where future satellite coverage will be available, and providing the prediction to user equipment devices in locations where the cellular network is not available.

Generally, program modules comprise routines, programs, components, data structures, etc., that perform particular tasks or implement particular abstract data types. Moreover, those skilled in the art will appreciate that the methods can be practiced with other computer system configurations, comprising single-processor or multiprocessor computer systems, minicomputers, mainframe computers, as well as personal computers, hand-held computing devices, microprocessor-based or programmable consumer electronics, and the like, each of which can be operatively coupled to one or more associated devices.

As used herein, a processing circuit includes one or more processors as well as other application specific circuits such as an application specific integrated circuit, digital logic circuit, state machine, programmable gate array or other circuit that processes input signals or data and that produces output signals or data in response thereto. It should be noted that while any functions and features described herein in association with the operation of a processor could likewise be performed by a processing circuit.

The illustrated embodiments of the embodiments herein can also be practiced in distributed computing environments where certain tasks are performed by remote processing devices that are linked through a communications network. In a distributed computing environment, program modules can be located in both local and remote memory storage devices.

Computing devices typically comprise a variety of media, which can comprise computer-readable storage media and/or communications media, which two terms are used herein differently from one another as follows. Computer-readable storage media can be any available storage media that can be accessed by the computer and comprises both volatile and nonvolatile media, removable and non-removable media. By way of example, and not limitation, computer-readable storage media can be implemented in connection with any method or technology for storage of information such as computer-readable instructions, program modules, structured data or unstructured data.

Computer-readable storage media can comprise, but are not limited to, random access memory (RAM), read only memory (ROM), electrically erasable programmable read only memory (EEPROM), flash memory or other memory technology, compact disk read only memory (CD-ROM), digital versatile disk (DVD) or other optical disk storage, magnetic cassettes, magnetic tape, magnetic disk storage or other magnetic storage devices or other tangible and/or non-transitory media which can be used to store desired information. In this regard, the terms “tangible” or “non-transitory” herein as applied to storage, memory or computer-readable media, are to be understood to exclude only propagating transitory signals per se as modifiers and do not relinquish rights to all standard storage, memory or computer-readable media that are not only propagating transitory signals per se.

Computer-readable storage media can be accessed by one or more local or remote computing devices, e.g., via access requests, queries or other data retrieval protocols, for a variety of operations with respect to the information stored by the medium.

Communications media typically embody computer-readable instructions, data structures, program modules or other structured or unstructured data in a data signal such as a modulated data signal, e.g., a carrier wave or other transport mechanism, and comprises any information delivery or transport media. The term “modulated data signal” or signals refers to a signal that has one or more of its characteristics set or changed in such a manner as to encode information in one or more signals. By way of example, and not limitation, communication media comprise wired media, such as a wired network or direct-wired connection, and wireless media such as acoustic, RF, infrared and other wireless media.

With reference again to FIG. 4, the example environment can comprise a computer 402, the computer 402 comprising a processing unit 404, a system memory 406 and a system bus 408. The system bus 408 couples system components including, but not limited to, the system memory 406 to the processing unit 404. The processing unit 404 can be any of various commercially available processors. Dual microprocessors and other multiprocessor architectures can also be employed as the processing unit 404.

The system bus 408 can be any of several types of bus structure that can further interconnect to a memory bus (with or without a memory controller), a peripheral bus, and a local bus using any of a variety of commercially available bus architectures. The system memory 406 comprises ROM 410 and RAM 412. A basic input/output system (BIOS) can be stored in a non-volatile memory such as ROM, erasable programmable read only memory (EPROM), EEPROM, which BIOS contains the basic routines that help to transfer information between elements within the computer 402, such as during startup. The RAM 412 can also comprise a high-speed RAM such as static RAM for caching data.

The computer 402 further comprises an internal hard disk drive (HDD) 414 (e.g., EIDE, SATA), which internal HDD 414 can also be configured for external use in a suitable chassis (not shown), a magnetic floppy disk drive (FDD) 416, (e.g., to read from or write to a removable diskette 418) and an optical disk drive 420, (e.g., reading a CD-ROM disk 422 or, to read from or write to other high-capacity optical media such as the DVD). The HDD 414, magnetic FDD 416 and optical disk drive 420 can be connected to the system bus 408 by a hard disk drive interface 424, a magnetic disk drive interface 426 and an optical drive interface 428, respectively. The hard disk drive interface 424 for external drive implementations comprises at least one or both of Universal Serial Bus (USB) and Institute of Electrical and Electronics Engineers (IEEE) 1394 interface technologies. Other external drive connection technologies are within contemplation of the embodiments described herein.

The drives and their associated computer-readable storage media provide nonvolatile storage of data, data structures, computer-executable instructions, and so forth. For the computer 402, the drives and storage media accommodate the storage of any data in a suitable digital format. Although the description of computer-readable storage media above refers to a hard disk drive (HDD), a removable magnetic diskette, and a removable optical media such as a CD or DVD, it should be appreciated by those skilled in the art that other types of storage media which are readable by a computer, such as zip drives, magnetic cassettes, flash memory cards, cartridges, and the like, can also be used in the example operating environment, and further, that any such storage media can contain computer-executable instructions for performing the methods described herein.

A number of program modules can be stored in the drives and RAM 412, comprising an operating system 430, one or more application programs 432, other program modules 434 and program data 436. All or portions of the operating system, applications, modules, and/or data can also be cached in the RAM 412. The systems and methods described herein can be implemented utilizing various commercially available operating systems or combinations of operating systems.

A user can enter commands and information into the computer 402 through one or more wired/wireless input devices, e.g., a keyboard 438 and a pointing device, such as a mouse 440. Other input devices (not shown) can comprise a microphone, an infrared (IR) remote control, a joystick, a game pad, a stylus pen, touch screen or the like. These and other input devices are often connected to the processing unit 404 through an input device interface 442 that can be coupled to the system bus 408, but can be connected by other interfaces, such as a parallel port, an IEEE 1394 serial port, a game port, a universal serial bus (USB) port, an IR interface, etc.

A monitor 444 or other type of display device can also be connected to the system bus 408 via an interface, such as a video adapter 446. It will also be appreciated that in alternative embodiments, a monitor 444 can also be any display device (e.g., another computer having a display, a smart phone, a tablet computer, etc.) for receiving display information associated with computer 402 via any communication means, including via the Internet and cloud-based networks. In addition to the monitor 444, a computer typically comprises other peripheral output devices (not shown), such as speakers, printers, etc.

The computer 402 can operate in a networked environment using logical connections via wired and/or wireless communications to one or more remote computers, such as a remote computer(s) 448. The remote computer(s) 448 can be a workstation, a server computer, a router, a personal computer, portable computer, microprocessor-based entertainment appliance, a peer device or other common network node, and typically comprises many or all of the elements described relative to the computer 402, although, for purposes of brevity, only a remote memory/storage device 450 is illustrated. The logical connections depicted comprise wired/wireless connectivity to a local area network (LAN) 452 and/or larger networks, e.g., a wide area network (WAN) 454. Such LAN and WAN networking environments are commonplace in offices and companies, and facilitate enterprise-wide computer networks, such as intranets, all of which can connect to a global communications network, e.g., the Internet.

When used in a LAN networking environment, the computer 402 can be connected to the LAN 452 through a wired and/or wireless communication network interface or adapter 456. The adapter 456 can facilitate wired or wireless communication to the LAN 452, which can also comprise a wireless AP disposed thereon for communicating with the adapter 456.

When used in a WAN networking environment, the computer 402 can comprise a modem 458 or can be connected to a communications server on the WAN 454 or has other means for establishing communications over the WAN 454, such as by way of the Internet. The modem 458, which can be internal or external and a wired or wireless device, can be connected to the system bus 408 via the input device interface 442. In a networked environment, program modules depicted relative to the computer 402 or portions thereof, can be stored in the remote memory/storage device 450. It will be appreciated that the network connections shown are example and other means of establishing a communications link between the computers can be used.

The computer 402 can be operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, restroom), and telephone. This can comprise Wireless Fidelity (Wi-Fi) and BLUETOOTH® wireless technologies. Thus, the communication can be a predefined structure as with a conventional network or simply an ad hoc communication between at least two devices.

Wi-Fi can allow connection to the Internet from a couch at home, a bed in a hotel room or a conference room at work, without wires. Wi-Fi is a wireless technology similar to that used in a cell phone that enables such devices, e.g., computers, to send and receive data indoors and out; anywhere within the range of a base station. Wi-Fi networks use radio technologies called IEEE 802.11 (a, b, g, n, ac, ag, etc.) to provide secure, reliable, fast wireless connectivity. A Wi-Fi network can be used to connect computers to each other, to the Internet, and to wired networks (which can use IEEE 802.3 or Ethernet). Wi-Fi networks operate in the unlicensed 2.4 and 5 GHz radio bands for example or with products that contain both bands (dual band), so the networks can provide real-world performance similar to the basic 10BaseT wired Ethernet networks used in many offices.

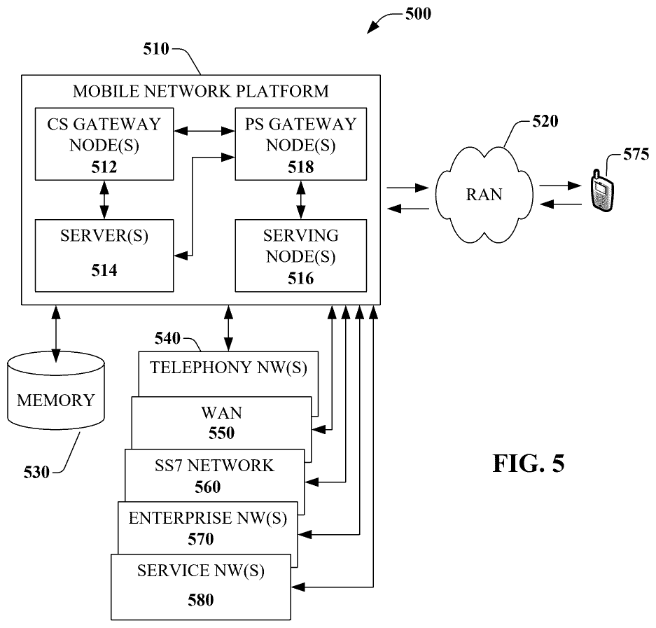

Turning now to FIG. 5, an embodiment 500 of a mobile network platform 510 is shown that is an example of network elements 150, 152, 154, 156, and/or VNEs 330, 332, 334, etc. For example, platform 510 can facilitate in whole or in part receiving sensor data from user equipment devices such as radiotelephone 575 on a cellular network that sense pilot signals from orbiting satellites, predicting where future satellite coverage will be available, and providing the prediction to user equipment devices such as radiotelephone 575 in locations where the cellular network is not available. In one or more embodiments, the mobile network platform 510 can generate and receive signals transmitted and received by base stations or access points such as base station or access point 122. Generally, mobile network platform 510 can comprise components, e.g., nodes, gateways, interfaces, servers, or disparate platforms, that facilitate both packet-switched (PS) (e.g., internet protocol (IP), frame relay, asynchronous transfer mode (ATM)) and circuit-switched (CS) traffic (e.g., voice and data), as well as control generation for networked wireless telecommunication. As a non-limiting example, mobile network platform 510 can be included in telecommunications carrier networks and can be considered carrier-side components as discussed elsewhere herein. Mobile network platform 510 comprises CS gateway node(s) 512 which can interface CS traffic received from legacy networks like telephony network(s) 540 (e.g., public switched telephone network (PSTN), or public land mobile network (PLMN)) or a signaling system #7 (SS7) network 560. CS gateway node(s) 512 can authorize and authenticate traffic (e.g., voice) arising from such networks. Additionally, CS gateway node(s) 512 can access mobility, or roaming, data generated through SS7 network 560; for instance, mobility data stored in a visited location register (VLR), which can reside in memory 530. Moreover, CS gateway node(s) 512 interfaces CS-based traffic and signaling and PS gateway node(s) 518. As an example, in a 3GPP UMTS network, CS gateway node(s) 512 can be realized at least in part in gateway GPRS support node(s) (GGSN). It should be appreciated that functionality and specific operation of CS gateway node(s) 512, PS gateway node(s) 518, and serving node(s) 516, is provided and dictated by radio technologies utilized by mobile network platform 510 for telecommunication over a radio access network 520 with other devices, such as a radiotelephone 575.

In addition to receiving and processing CS-switched traffic and signaling, PS gateway node(s) 518 can authorize and authenticate PS-based data sessions with served mobile devices. Data sessions can comprise traffic, or content(s), exchanged with networks external to the mobile network platform 510, like wide area network(s) (WANs) 550, enterprise network(s) 570, and service network(s) 580, which can be embodied in local area network(s) (LANs), can also be interfaced with mobile network platform 510 through PS gateway node(s) 518. It is to be noted that WANs 550 and enterprise network(s) 570 can embody, at least in part, a service network(s) like IP multimedia subsystem (IMS). Based on radio technology layer(s) available in technology resource(s) or radio access network 520, PS gateway node(s) 518 can generate packet data protocol contexts when a data session is established; other data structures that facilitate routing of packetized data also can be generated. To that end, in an aspect, PS gateway node(s) 518 can comprise a tunnel interface (e.g., tunnel termination gateway (TTG) in 3GPP UMTS network(s) (not shown)) which can facilitate packetized communication with disparate wireless network(s), such as Wi-Fi networks.

In embodiment 500, mobile network platform 510 also comprises serving node(s) 516 that, based upon available radio technology layer(s) within technology resource(s) in the radio access network 520, convey the various packetized flows of data streams received through PS gateway node(s) 518. It is to be noted that for technology resource(s) that rely primarily on CS communication, server node(s) can deliver traffic without reliance on PS gateway node(s) 518; for example, server node(s) can embody at least in part a mobile switching center. As an example, in a 3GPP UMTS network, serving node(s) 516 can be embodied in serving GPRS support node(s) (SGSN).

For radio technologies that exploit packetized communication, server(s) 514 in mobile network platform 510 can execute numerous applications that can generate multiple disparate packetized data streams or flows, and manage (e.g., schedule, queue, format . . . ) such flows. Such application(s) can comprise add-on features to standard services (for example, provisioning, billing, customer support . . . ) provided by mobile network platform 510. Data streams (e.g., content(s) that are part of a voice call or data session) can be conveyed to PS gateway node(s) 518 for authorization/authentication and initiation of a data session, and to serving node(s) 516 for communication thereafter. In addition to application server, server(s) 514 can comprise utility server(s), a utility server can comprise a provisioning server, an operations and maintenance server, a security server that can implement at least in part a certificate authority and firewalls as well as other security mechanisms, and the like. In an aspect, security server(s) secure communication served through mobile network platform 510 to ensure network's operation and data integrity in addition to authorization and authentication procedures that CS gateway node(s) 512 and PS gateway node(s) 518 can enact. Moreover, provisioning server(s) can provision services from external network(s) like networks operated by a disparate service provider; for instance, WAN 550 or Global Positioning System (GPS) network(s) (not shown). Provisioning server(s) can also provision coverage through networks associated to mobile network platform 510 (e.g., deployed and operated by the same service provider), such as the distributed antennas networks shown in FIG. 1(s) that enhance wireless service coverage by providing more network coverage.

It is to be noted that server(s) 514 can comprise one or more processors configured to confer at least in part the functionality of mobile network platform 510. To that end, the one or more processors can execute code instructions stored in memory 530, for example. It should be appreciated that server(s) 514 can comprise a content manager, which operates in substantially the same manner as described hereinbefore.

In example embodiment 500, memory 530 can store information related to operation of mobile network platform 510. Other operational information can comprise provisioning information of mobile devices served through mobile network platform 510, subscriber databases; application intelligence, pricing schemes, e.g., promotional rates, flat-rate programs, couponing campaigns; technical specification(s) consistent with telecommunication protocols for operation of disparate radio, or wireless, technology layers; and so forth. Memory 530 can also store information from at least one of telephony network(s) 540, WAN 550, SS7 network 560, or enterprise network(s) 570. In an aspect, memory 530 can be, for example, accessed as part of a data store component or as a remotely connected memory store.

In order to provide a context for the various aspects of the disclosed subject matter, FIG. 5, and the following discussion, are intended to provide a brief, general description of a suitable environment in which the various aspects of the disclosed subject matter can be implemented. While the subject matter has been described above in the general context of computer-executable instructions of a computer program that runs on a computer and/or computers, those skilled in the art will recognize that the disclosed subject matter also can be implemented in combination with other program modules. Generally, program modules comprise routines, programs, components, data structures, etc. that perform particular tasks and/or implement particular abstract data types.

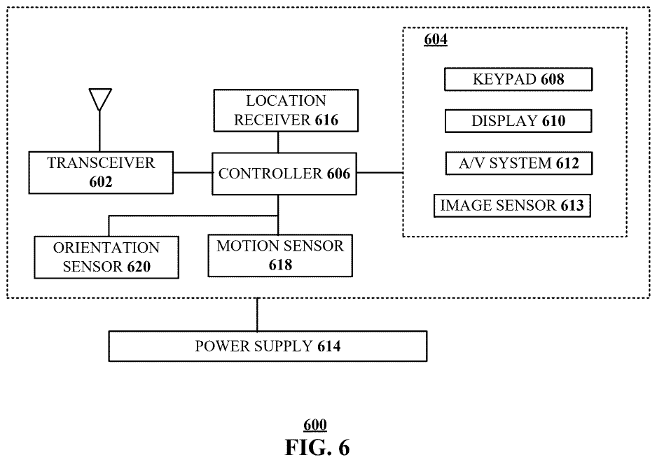

Turning now to FIG. 6, an illustrative embodiment of a communication device 600 is shown. The communication device 600 can serve as an illustrative embodiment of devices such as data terminals 114, mobile devices 124, vehicle 126, display devices 144 or other client devices for communication via either communications network 125. For example, communication device 600 can facilitate in whole or in part receiving sensor data from user equipment devices such as communication device 600 on a cellular network that sense pilot signals from orbiting satellites, predicting where future satellite coverage will be available, and providing the prediction to user equipment devices such as communication device 600 in locations where the cellular network is not available.

The communication device 600 can comprise a wireline and/or wireless transceiver 602 (herein transceiver 602), a user interface (UI) 604, a power supply 614, a location receiver 616, a motion sensor 618, an orientation sensor 620, and a controller 606 for managing operations thereof. The transceiver 602 can support short-range or long-range wireless access technologies such as Bluetooth®, ZigBee®, Wi-Fi, DECT, or cellular communication technologies, just to mention a few (Bluetooth® and ZigBee® are trademarks registered by the Bluetooth® Special Interest Group and the ZigBee® Alliance, respectively). Cellular technologies can include, for example, CDMA-1X, UMTS/HSDPA, GSM/GPRS, TDMA/EDGE, EV/DO, WiMAX, SDR, LTE, as well as other next generation wireless communication technologies as they arise. The transceiver 602 can also be adapted to support circuit-switched wireline access technologies (such as PSTN), packet-switched wireline access technologies (such as TCP/IP, VoIP, etc.), and combinations thereof.

The UI 604 can include a depressible or touch-sensitive keypad 608 with a navigation mechanism such as a roller ball, a joystick, a mouse, or a navigation disk for manipulating operations of the communication device 600. The keypad 608 can be an integral part of a housing assembly of the communication device 600 or an independent device operably coupled thereto by a tethered wireline interface (such as a USB cable) or a wireless interface supporting for example Bluetooth®. The keypad 608 can represent a numeric keypad commonly used by phones, and/or a QWERTY keypad with alphanumeric keys. The UI 604 can further include a display 610 such as monochrome or color LCD (Liquid Crystal Display), OLED (Organic Light Emitting Diode) or other suitable display technology for conveying images to an end user of the communication device 600. In an embodiment where the display 610 is touch-sensitive, a portion or all of the keypad 608 can be presented by way of the display 610 with navigation features.

The display 610 can use touch screen technology to also serve as a user interface for detecting user input. As a touch screen display, the communication device 600 can be adapted to present a user interface having graphical user interface (GUI) elements that can be selected by a user with a touch of a finger. The display 610 can be equipped with capacitive, resistive or other forms of sensing technology to detect how much surface area of a user's finger has been placed on a portion of the touch screen display. This sensing information can be used to control the manipulation of the GUI elements or other functions of the user interface. The display 610 can be an integral part of the housing assembly of the communication device 600 or an independent device communicatively coupled thereto by a tethered wireline interface (such as a cable) or a wireless interface.

The UI 604 can also include an audio system 612 that utilizes audio technology for conveying low volume audio (such as audio heard in proximity of a human ear) and high-volume audio (such as speakerphone for hands free operation). The audio system 612 can further include a microphone for receiving audible signals of an end user. The audio system 612 can also be used for voice recognition applications. The UI 604 can further include an image sensor 613 such as a charged coupled device (CCD) camera for capturing still or moving images.

The power supply 614 can utilize common power management technologies such as replaceable and rechargeable batteries, supply regulation technologies, and/or charging system technologies for supplying energy to the components of the communication device 600 to facilitate long-range or short-range portable communications. Alternatively, or in combination, the charging system can utilize external power sources such as DC power supplied over a physical interface such as a USB port or other suitable tethering technologies.

The location receiver 616 can utilize location technology such as a global positioning system (GPS) receiver capable of assisted GPS for identifying a location of the communication device 600 based on signals generated by a constellation of GPS satellites, which can be used for facilitating location services such as navigation. The motion sensor 618 can utilize motion sensing technology such as an accelerometer, a gyroscope, or other suitable motion sensing technology to detect motion of the communication device 600 in three-dimensional space. The orientation sensor 620 can utilize orientation sensing technology such as a magnetometer to detect the orientation of the communication device 600 (north, south, west, and east, as well as combined orientations in degrees, minutes, or other suitable orientation metrics).

The communication device 600 can use the transceiver 602 to also determine a proximity to a cellular, Wi-Fi, Bluetooth®, or other wireless access points by sensing techniques such as utilizing a received signal strength indicator (RSSI) and/or signal time of arrival (TOA) or time of flight (TOF) measurements. The controller 606 can utilize computing technologies such as a microprocessor, a digital signal processor (DSP), programmable gate arrays, application specific integrated circuits, and/or a video processor with associated storage memory such as Flash, ROM, RAM, SRAM, DRAM or other storage technologies for executing computer instructions, controlling, and processing data supplied by the aforementioned components of the communication device 600.

Other components not shown in FIG. 6 can be used in one or more embodiments of the subject disclosure. For instance, the communication device 600 can include a slot for adding or removing an identity module such as a Subscriber Identity Module (SIM) card or Universal Integrated Circuit Card (UICC). SIM or UICC cards can be used for identifying subscriber services, executing programs, storing subscriber data, and so on.

The terms “first,” “second,” “third,” and so forth, as used in the claims, unless otherwise clear by context, is for clarity only and does not otherwise indicate or imply any order in time. For instance, “a first determination,” “a second determination,” and “a third determination,” does not indicate or imply that the first determination is to be made before the second determination, or vice versa, etc.

In the subject specification, terms such as “store,” “storage,” “data store,” data storage,” “database,” and substantially any other information storage component relevant to operation and functionality of a component, refer to “memory components,” or entities embodied in a “memory” or components comprising the memory. It will be appreciated that the memory components described herein can be either volatile memory or nonvolatile memory, or can comprise both volatile and nonvolatile memory, by way of illustration, and not limitation, volatile memory, non-volatile memory, disk storage, and memory storage. Further, nonvolatile memory can be included in read only memory (ROM), programmable ROM (PROM), electrically programmable ROM (EPROM), electrically erasable ROM (EEPROM), or flash memory. Volatile memory can comprise random access memory (RAM), which acts as external cache memory. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM). Additionally, the disclosed memory components of systems or methods herein are intended to comprise, without being limited to comprising, these and any other suitable types of memory.

Moreover, it will be noted that the disclosed subject matter can be practiced with other computer system configurations, comprising single-processor or multiprocessor computer systems, mini-computing devices, mainframe computers, as well as personal computers, hand-held computing devices (e.g., PDA, phone, smartphone, watch, tablet computers, netbook computers, etc.), microprocessor-based or programmable consumer or industrial electronics, and the like. The illustrated aspects can also be practiced in distributed computing environments where tasks are performed by remote processing devices that are linked through a communications network; however, some if not all aspects of the subject disclosure can be practiced on stand-alone computers. In a distributed computing environment, program modules can be located in both local and remote memory storage devices.

In one or more embodiments, information regarding use of services can be generated including services being accessed, media consumption history, user preferences, and so forth. This information can be obtained by various methods including user input, detecting types of communications (e.g., video content vs. audio content), analysis of content streams, sampling, and so forth. The generating, obtaining and/or monitoring of this information can be responsive to an authorization provided by the user. In one or more embodiments, an analysis of data can be subject to authorization from user(s) associated with the data, such as an opt-in, an opt-out, acknowledgement requirements, notifications, selective authorization based on types of data, and so forth.

Some of the embodiments described herein can also employ artificial intelligence (AI) to facilitate automating one or more features described herein. The embodiments (e.g., in connection with automatically identifying acquired cell sites that provide a maximum value/benefit after addition to an existing communication network) can employ various AI-based schemes for carrying out various embodiments thereof. Moreover, the classifier can be employed to determine a ranking or priority of each cell site of the acquired network. A classifier is a function that maps an input attribute vector, x=(x₁, x₂, x₃, x₄ . . . xₙ), to a confidence that the input belongs to a class, that is, f(x)=confidence (class). Such classification can employ a probabilistic and/or statistical-based analysis (e.g., factoring into the analysis utilities and costs) to determine or infer an action that a user desires to be automatically performed. A support vector machine (SVM) is an example of a classifier that can be employed. The SVM operates by finding a hypersurface in the space of possible inputs, which the hypersurface attempts to split the triggering criteria from the non-triggering events. Intuitively, this makes the classification correct for testing data that is near, but not identical to training data. Other directed and undirected model classification approaches comprise, e.g., naïve Bayes, Bayesian networks, decision trees, neural networks, fuzzy logic models, and probabilistic classification models providing different patterns of independence can be employed. Classification as used herein also is inclusive of statistical regression that is utilized to develop models of priority.

As will be readily appreciated, one or more of the embodiments can employ classifiers that are explicitly trained (e.g., via a generic training data) as well as implicitly trained (e.g., via observing UE behavior, operator preferences, historical information, receiving extrinsic information). For example, SVMs can be configured via a learning or training phase within a classifier constructor and feature selection module. Thus, the classifier(s) can be used to automatically learn and perform a number of functions, including but not limited to determining according to predetermined criteria which of the acquired cell sites will benefit a maximum number of subscribers and/or which of the acquired cell sites will add minimum value to the existing communication network coverage, etc.

As used in some contexts in this application, in some embodiments, the terms “component,” “system” and the like are intended to refer to, or comprise, a computer-related entity or an entity related to an operational apparatus with one or more specific functionalities, wherein the entity can be either hardware, a combination of hardware and software, software, or software in execution. As an example, a component may be, but is not limited to being, a process running on a processor, a processor, an object, an executable, a thread of execution, computer-executable instructions, a program, and/or a computer. By way of illustration and not limitation, both an application running on a server and the server can be a component. One or more components may reside within a process and/or thread of execution and a component may be localized on one computer and/or distributed between two or more computers. In addition, these components can execute from various computer readable media having various data structures stored thereon. The components may communicate via local and/or remote processes such as in accordance with a signal having one or more data packets (e.g., data from one component interacting with another component in a local system, distributed system, and/or across a network such as the Internet with other systems via the signal). As another example, a component can be an apparatus with specific functionality provided by mechanical parts operated by electric or electronic circuitry, which is operated by a software or firmware application executed by a processor, wherein the processor can be internal or external to the apparatus and executes at least a part of the software or firmware application. As yet another example, a component can be an apparatus that provides specific functionality through electronic components without mechanical parts, the electronic components can comprise a processor therein to execute software or firmware that confers at least in part the functionality of the electronic components. While various components have been illustrated as separate components, it will be appreciated that multiple components can be implemented as a single component, or a single component can be implemented as multiple components, without departing from example embodiments.

Further, the various embodiments can be implemented as a method, apparatus or article of manufacture using standard programming and/or engineering techniques to produce software, firmware, hardware or any combination thereof to control a computer to implement the disclosed subject matter. The term “article of manufacture” as used herein is intended to encompass a computer program accessible from any computer-readable device or computer-readable storage/communications media. For example, computer readable storage media can include, but are not limited to, magnetic storage devices (e.g., hard disk, floppy disk, magnetic strips), optical disks (e.g., compact disk (CD), digital versatile disk (DVD)), smart cards, and flash memory devices (e.g., card, stick, key drive). Of course, those skilled in the art will recognize many modifications can be made to this configuration without departing from the scope or spirit of the various embodiments.

In addition, the words “example” and “exemplary” are used herein to mean serving as an instance or illustration. Any embodiment or design described herein as “example” or “exemplary” is not necessarily to be construed as preferred or advantageous over other embodiments or designs. Rather, use of the word example or exemplary is intended to present concepts in a concrete fashion. As used in this application, the term “or” is intended to mean an inclusive “or” rather than an exclusive “or”. That is, unless specified otherwise or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

Moreover, terms such as “user equipment,” “mobile station,” “mobile,” subscriber station,” “access terminal,” “terminal,” “handset,” “mobile device” (and/or terms representing similar terminology) can refer to a wireless device utilized by a subscriber or user of a wireless communication service to receive or convey data, control, voice, video, sound, gaming or substantially any data-stream or signaling-stream. The foregoing terms are utilized interchangeably herein and with reference to the related drawings.

Furthermore, the terms “user,” “subscriber,” “customer,” “consumer” and the like are employed interchangeably throughout, unless context warrants particular distinctions among the terms. It should be appreciated that such terms can refer to human entities or automated components supported through artificial intelligence (e.g., a capacity to make inference based, at least, on complex mathematical formalisms), which can provide simulated vision, sound recognition and so forth.

As employed herein, the term “processor” can refer to substantially any computing processing unit or device comprising, but not limited to comprising, single-core processors; single-processors with software multithread execution capability; multi-core processors; multi-core processors with software multithread execution capability; multi-core processors with hardware multithread technology; parallel platforms; and parallel platforms with distributed shared memory. Additionally, a processor can refer to an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components or any combination thereof designed to perform the functions described herein. Processors can exploit nano-scale architectures such as, but not limited to, molecular and quantum-dot based transistors, switches and gates, in order to optimize space usage or enhance performance of user equipment. A processor can also be implemented as a combination of computing processing units.

As used herein, terms such as “data storage,” data storage,” “database,” and substantially any other information storage component relevant to operation and functionality of a component, refer to “memory components,” or entities embodied in a “memory” or components comprising the memory. It will be appreciated that the memory components or computer-readable storage media, described herein can be either volatile memory or nonvolatile memory or can include both volatile and nonvolatile memory.

What has been described above includes mere examples of various embodiments. It is, of course, not possible to describe every conceivable combination of components or methodologies for purposes of describing these examples, but one of ordinary skill in the art can recognize that many further combinations and permutations of the present embodiments are possible. Accordingly, the embodiments disclosed and/or claimed herein are intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

In addition, a flow diagram may include a “start” and/or “continue” indication. The “start” and “continue” indications reflect that the steps presented can optionally be incorporated in or otherwise used in conjunction with other routines. In this context, “start” indicates the beginning of the first step presented and may be preceded by other activities not specifically shown. Further, the “continue” indication reflects that the steps presented may be performed multiple times and/or may be succeeded by other activities not specifically shown. Further, while a flow diagram indicates a particular ordering of steps, other orderings are likewise possible provided that the principles of causality are maintained.

As may also be used herein, the term(s) “operably coupled to”, “coupled to”, and/or “coupling” includes direct coupling between items and/or indirect coupling between items via one or more intervening items. Such items and intervening items include, but are not limited to, junctions, communication paths, components, circuit elements, circuits, functional blocks, and/or devices. As an example of indirect coupling, a signal conveyed from a first item to a second item may be modified by one or more intervening items by modifying the form, nature or format of information in a signal, while one or more elements of the information in the signal are nevertheless conveyed in a manner than can be recognized by the second item. In a further example of indirect coupling, an action in a first item can cause a reaction on the second item, as a result of actions and/or reactions in one or more intervening items.

Although specific embodiments have been illustrated and described herein, it should be appreciated that any arrangement which achieves the same or similar purpose may be substituted for the embodiments described or shown by the subject disclosure. The subject disclosure is intended to cover any and all adaptations or variations of various embodiments. Combinations of the above embodiments, and other embodiments not specifically described herein, can be used in the subject disclosure. For instance, one or more features from one or more embodiments can be combined with one or more features of one or more other embodiments. In one or more embodiments, features that are positively recited can also be negatively recited and excluded from the embodiment with or without replacement by another structural and/or functional feature. The steps or functions described with respect to the embodiments of the subject disclosure can be performed in any order. The steps or functions described with respect to the embodiments of the subject disclosure can be performed alone or in combination with other steps or functions of the subject disclosure, as well as from other embodiments or from other steps that have not been described in the subject disclosure. Further, more than or less than all of the features described with respect to an embodiment can also be utilized.

What is claimed is:

1. A method, comprising:
receiving, by a processing system including a processor, from a plurality of user equipment (UE) devices in communication with a terrestrial network, information about coverage by a non-terrestrial network in a current coverage area of the non-terrestrial network;
predicting, by the processing system, future coverage areas of the non-terrestrial network, wherein the predicting is based on the information about the coverage by the non-terrestrial network in the current coverage area; and
providing, by the processing system, coverage information about predicted future coverage areas to remote UE devices in areas with no coverage from the terrestrial network, the coverage information enabling the remote UE device to connect to the non-terrestrial network when the coverage by the non-terrestrial network becomes available for the remote UE devices.

2. The method of claim 1, wherein the providing coverage information about the predicted future coverage areas to the remote UE devices comprises:
providing, by the processing system, information about a proximity to a constellation edge for a remote UE of the UE devices, wherein the constellation edge defines a limit of the coverage by the non-terrestrial network at a location of the remote UE; and
providing, by the processing system, information about a proximity to a gap in the coverage by the non-terrestrial network at the location of the remote UE, the proximity to a constellation edge and the information about the proximity to the gap for use by the remote UE to control activity by the remote UE in a high-power active mode for communication with the non-terrestrial network.

3. The method of claim 2, wherein the providing coverage information about the predicted future coverage areas to the remote UE devices comprises:
providing, by the processing system, information about a likelihood of coverage from the coverage by the non-terrestrial network at the location of the remote UE; and
providing, by the processing system, information about a gap duration corresponding to a time duration of the gap in the coverage by the non-terrestrial network at the location of the remote UE, the information about the gap duration for use by the remote UE to time a duration of a low power sleep mode during the gap in the coverage by the non-terrestrial network at the location of the remote UE.

4. The method of claim 1, wherein the predicting the future coverage areas of the non-terrestrial network comprises:
estimating, by the processing system, a likelihood of detecting a satellite signal by a remote UE when the remote UE is at a UE location in an area with no coverage from the terrestrial network and only the coverage by the non-terrestrial network is available.

5. The method of claim 4, wherein the predicting the future coverage areas of the non-terrestrial network further comprises:
estimating, by the processing system, a gap duration corresponding to a time duration of a gap in the coverage by the non-terrestrial network at the UE location of the remote UE.

6. The method of claim 5, wherein the predicting the future coverage areas of the non-terrestrial network further comprises:
modeling, by the processing system, a size and a shape of a future coverage area of the non-terrestrial network, wherein the modeling is based on the information about the coverage by the non-terrestrial network in the current coverage area; and
modeling, by the processing system, movement of the future coverage area of the non-terrestrial network to areas including the future coverage areas.

7. The method of claim 6, wherein the modeling the size and the shape of the future coverage area of the non-terrestrial network comprises:
establishing by the processing system, a coverage grid approximating the shape of the future coverage area of the non-terrestrial network, the coverage grid including a plurality of quadrants; and
assigning, by the processing system, a likelihood of coverage value to each quadrant of the plurality of quadrants, the likelihood of coverage value corresponding to the coverage by the non-terrestrial network in the quadrant when the remote UE is in a position corresponding to the quadrant of the coverage grid when the future coverage area corresponds to location of the remote UE.

8. The method of claim 7, comprising:
assigning, by the processing system, a gap duration value to each quadrant of the plurality of quadrants, the gap duration value corresponding to a time duration of a gap in the coverage by the non-terrestrial network in the quadrant when the remote UE is in a position corresponding to the quadrant of the coverage grid when the future coverage area corresponds to the location of the remote UE;
assigning, by the processing system, a proximity to gap value to each quadrant of the plurality of quadrants, the proximity to gap value corresponding to a distance of the remote UE from the gap in the coverage by the non-terrestrial network in the quadrant when the remote UE is in a position corresponding to the quadrant of the coverage grid when the future coverage area corresponds to the location of the remote UE; and
assigning, by the processing system, a proximity to coverage edge value to each quadrant of the plurality of quadrants, the proximity to coverage edge value corresponding to a distance of the remote UE from an edge the future coverage area of the coverage by the non-terrestrial network in the quadrant when the remote UE is in a position corresponding to the quadrant of the coverage grid when the future coverage area corresponds to location of the remote UE.

9. The method of claim 7, further comprising:
receiving, by the processing system, current location information for the remote UE;
locating, by the processing system, the remote UE in a current quadrant of the plurality of quadrants of the coverage grid;
determining, by the processing system, coverage parameters for the remote UE at the current quadrant of the coverage grid; and
providing, by the processing system, information about the coverage parameters with the coverage information to the remote UE.

10. The method of claim 1, wherein the providing coverage information about predicted future coverage areas comprises:
providing, by the processing system, information about time periods when the coverage by the non-terrestrial network is not available for the remote UE devices to limit searching for coverage and battery drain by the remote UE devices.

11. A device, comprising:
a processing system including a processor; and
a memory that stores executable instructions that, when executed by the processing system, facilitate performance of operations, the operations comprising:
obtaining sensor information that is collected by a plurality of user equipment (UE) devices, the sensor information about a presence of satellite coverage in a non-terrestrial network at respective locations of respective UE devices;
modeling a configuration of a coverage area of the satellite coverage, wherein the modeling is based on the sensor information;
receiving, from a remote UE, information about a current location of the remote UE, the remote UE in communication with the non-terrestrial network; and
providing, to the remote UE, coverage information for future satellite coverage of the non-terrestrial network, the coverage information to enable the remote UE to schedule low-power operations during times when the future satellite coverage of the non-terrestrial network is not available at the current location of the remote UE.

12. The device of claim 11, wherein the obtaining the sensor comprises:
receiving, from respective UE devices, satellite identification information for a satellite of the non-terrestrial network; and
receiving, from the respective UE devices, respective location information for the respective UE devices.

13. The device of claim 11, wherein the operations further comprise:
directing the respective UE devices to detect a pilot signal of the satellite without attaching to the non-terrestrial network;
obtaining, from the respective UE devices, pilot signal presence information in the sensor information based on a detection of the pilot signal of the satellite; and
obtaining, from the respective UE devices, no pilot signal information in the sensor information based on no detection of the pilot signal of the satellite.

14. The device of claim 13, wherein the operations further comprise:
receiving, from the respective UE devices, respective signal strength information for the pilot signal of the satellite.

15. The device of claim 11, wherein the operations further comprise:
communicating with the plurality of UE devices over a terrestrial network associated with the non-terrestrial network.

16. A non-transitory machine-readable medium, comprising executable instructions that, when executed by a processing system including a processor, facilitate performance of operations, the operations comprising:
receiving sensor information from a plurality of user equipment (UE) devices attached to a cellular network, the sensor information determined by a respective UE device based on a presence of satellite coverage of a non-terrestrial network detected by the respective UE device at a respective location of the respective UE device;
predicting future coverage areas for the satellite coverage of the non-terrestrial network, wherein the predicting future coverage areas is based on the sensor information; and
providing, to a remote UE, information about future coverage areas and future coverage times for the satellite coverage of the non-terrestrial network to enable the remote UE to schedule future network access with the non-terrestrial network.

17. The non-transitory machine-readable medium of claim 16, wherein the predicting future coverage areas comprises:
establishing a coverage grid corresponding to a shape of a coverage area for the satellite coverage of a non-terrestrial network, the coverage grid including a plurality of quadrants; and
assigning a likelihood of coverage value to each quadrant of the plurality of quadrants, the likelihood of coverage determined based on the sensor information.

18. The non-transitory machine-readable medium of claim 17, wherein the assigning a likelihood of coverage value comprises:
assigning a relatively higher likelihood of coverage value to quadrants near a center of the coverage area; and
assigning a relatively lower likelihood of coverage value to quadrants near edges of the coverage area.

19. The non-transitory machine-readable medium of claim 17, wherein the operations further comprise:
receiving, from the remote UE, location information corresponding to a current location of the remote UE;
determining movement of the future coverage areas at future coverage times for the satellite coverage of the non-terrestrial network at the current location of the remote UE, the movement of the future coverage areas due to orbiting of a constellation of satellite of the non-terrestrial network;
locating the remote UE in a current quadrant of the coverage grid; and
determining coverage parameters for the UE at the current quadrant, wherein the determining the coverage parameters is based on the likelihood of coverage value to each quadrant.

20. The non-transitory machine-readable medium of claim 19, wherein the information about the future coverage areas and the future coverage times for the satellite coverage of the non-terrestrial network comprises:
providing the coverage parameters over the non-terrestrial network to the remote UE.
